(19) United States
(12) Patent Application Publication
(10) Pub. No.: US 2026/0181663 A1
(43) Pub. Date: Jun. 25, 2026

(54) COMMUNICATION METHOD AND DEVICE FOR OPEN RADIO ACCESS NETWORK O-RAN

(71) Applicant: Samsung Electronics Co., Ltd., Suwon-si (KR)

(72) Inventors: Jian YANG, Beijing (CN); Danye WU, Beijing (CN); Jaeyun KO, Suwon-si (KR); Min DONG, Beijing (CN); Ming JIN, Beijing (CN); Hyoseung KANG, Suwon-si (KR); Yelong ZHANG, Beijing (CN); Yougang HUANG, Beijing (CN)

(21) Appl. No.: 19/540,144

(22) Filed: Feb. 13, 2026

Related U.S. Application Data
(63) Continuation of application No. PCT/KR2024/012876, filed on Aug. 28, 2024.

(30) Foreign Application Priority Data
Sep. 1, 2023 (CN) 202311127159.5
Jul. 22, 2024 (CN) 202410985685.3

(51) Int. Cl. H04W 72/23

(52) U.S. Cl. CPC H04W 72/23

(57) ABSTRACT

A communication method and a device for an open radio access network (O-RAN) relating to the technical field of communication are provided. The method includes caching first control information for a signal transmitted periodically or repeatedly, and performing subsequent transmission based on the cached first control information.

### CROSS-REFERENCE TO RELATED APPLICATION(S)

This application is a continuation application, claiming priority under 35 U.S.C. § 365 (c), of an International application No. PCT/KR2024/012876, filed on Aug. 28, 2024, which is based on and claims the benefit of a Chinese patent application number 202311127159.5, filed on Sep. 1, 2023, in the Chinese Intellectual Property Office, and of a Chinese patent application number 202410985685.3, filed on Jul. 22, 2024, in the Chinese Intellectual Property Office, the disclosure of each of which is incorporated by reference herein in its entirety.

### BACKGROUND

### 1. Field

The disclosure relates to the technical field of communication. More particularly, the disclosure relates to a communication method and device for an open radio access network (O-RAN).

### 2. Description of Related Art

In an open radio access network (O-RAN), a fronthaul interface (FH IF) between an O-RAN distributed unit (O-DU) and an O-RAN radio unit (O-RU) is an open network. The transmission latency must be strictly required on limited bandwidth resources, and an effective reduction of the load on the fronthaul interface also needs to be considered and optimized in the O-RAN.

At present, an optimization of the fronthaul load in the O-RAN is mainly as follows: the user plane adopts various compression algorithms to reduce the number of bits required to transmit the same data, and the control plane reduces the number of bits of transmitted control message by various extensions.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a communication method and apparatus for an open radio access network (O-RAN), an electronic device, and a computer-readable storage medium, which can address the issue that a channel or signal with a periodic or repeated transmission characteristic cannot reduce the load of a fronthaul interface by the existing scheme.

Additional aspects will be set forth in part in the description which follows and, in part, will be apparent from the description, or may be learned by practice of the presented embodiments.

In accordance with an aspect of the disclosure, a communication method for an open radio access network (O-RAN), which is applied to an O-RAN radio unit (O-RU) is provided. The method includes caching first control information for a signal transmitted periodically or repeatedly, and performing subsequent transmission based on the cached first control information.

In some implementations of the disclosure, the method further includes receiving a control plane message transmitted by an O-RAN distributed unit (O-DU), the control plane message comprising at least one piece of the first control information.

In other implementations of the disclosure, the first control information includes first indication information for indicating whether to cache the first control information, and the caching first control information includes caching the first control information according to the first indication information for indicating whether to cache the first control information.

In other implementations of the disclosure, the method further includes determining whether to cache data to be transmitted that corresponds to the first control information, and if it is determined to cache the data to be transmitted, caching data to be transmitted in a user plane message transmitted by the O-DU, wherein the performing subsequent transmission based on the cached first control information includes transmitting the cached data to be transmitted based on the cached first control information.

In other implementations of the disclosure, the first indication information of the first control information includes a first information section extension, and the first information section extension includes at least one of the following extension fields a first extension field for indicating a section corresponding to the first control information, a second extension field for indicating activation or deactivation of caching the first control information, and a third extension field for indicating the remaining number of transmissions of the signal or channel.

In other implementations of the disclosure, the first information section extension further includes a fourth extension field for indicating whether the O-RU caches data to be transmitted that corresponds to the section.

In other implementations of the disclosure, if the second extension field is used for indicating the activation of caching the first control information, an indication value of the third extension field is 0, and the first information section extension further includes a fifth extension field for indicating a transmission period of the signal or channel.

In other implementations of the disclosure, if the second extension field is used for indicating the activation of caching the first control information, an indication value of the third extension field is not 0, and the first information section extension further includes a sixth extension field for indicating a time-domain starting position of each repeated transmission of the signal or channel.

In other implementations of the disclosure, the method further includes clearing the cached first control information after the remaining number of transmissions indicated by the third extension field is transmitted based on the cached first control information.

In other implementations of the disclosure, the method further includes if the data to be transmitted in the user plane message transmitted by the O-DU has been cached, clearing the cached data to be transmitted after the remaining number of transmissions indicated by the third extension field is transmitted based on the cached first control information.

In other implementations of the disclosure, if the second extension field is used for indicating the deactivation of caching the first control information, the method further includes clearing the cached first control information according to the extension fields in the first information section extension.

In other implementations of the disclosure, the method further includes if the data to be transmitted that corresponds to the first control information has been cached, clearing the cached data to be transmitted.

In other implementations of the disclosure, the extension fields in the first information section extension further includes a seventh extension field for indicating the number of sections to be stopped.

In other implementations of the disclosure, if an indication value of the seventh extension field is 0 for indicating that all sections in the O-RU stop to be transmitted, the first control information is all the cached control information, and if the indication value of the seventh extension field is not 0, the first control information is control information corresponding to the section indicated by the first extension field in the cached control information, wherein the number of the first extension field is the same as the indication value of the seventh extension field.

In other embodiments of the disclosure, the first control information further includes cached control plane information feedback indication information for indicating whether to feed back a recovery state of the cached control plane information, and the method further includes if it is determined to feed back the recovery state of each piece of the cached control plane information, indicating the recovery state of each piece of the cached control plane information as SUCCESSFUL through first information (e.g., acknowledgment (ACK)), and indicating the recovery state of each piece of the cached control plane information as FAILED through second information (e.g., negative acknowledgment (NACK)).

In other embodiments of the disclosure, the cached control plane information feedback indication information is statically configured, fed back and indicated through a management plane.

In other embodiments of the disclosure, the cached control plane information feedback indication information is dynamically fed back and indicated through a control plane.

In other implementations of the disclosure, if the section indicated by the first extension field has cached third control information, the method further includes clearing the cached third control information, and caching the first control information according to the section indicated by the first extension field.

In other implementations of the disclosure, the method further includes performing at least one of the following operations transmitting a first feedback message for caching the first control information to the O-DU, and transmitting a second feedback message for caching the data to be transmitted that corresponds to the first control information to the O-DU.

In other implementations of the disclosure, the method further includes updating a reception time window of a control plane message or a user plane message based on second control information.

In other implementations of the disclosure, the method further includes receiving a control plane message transmitted by the O-RAN distributed unit (O-DU), wherein the control plane message may further include the second control information.

In other implementations of the disclosure, the second control information includes control plane message reception time window information and user plane message reception time window information.

In other implementations of the disclosure, the control plane message reception time window information includes uplink control plane message reception time window information, and/or downlink control plane message reception time window information.

In other implementations of the disclosure, the user plane message reception time window information includes downlink user plane message reception time window information.

In other implementations of the disclosure, the uplink control plane message reception time window information includes an uplink control plane message reception time window offset and an uplink control plane message reception time window length.

In other implementations of the disclosure, the uplink control plane message reception time window offset includes an ending time of the updated uplink control plane message reception time window, or an offset value of the ending time of the updated uplink control plane message reception time window relative to an ending time of the configured uplink control plane message reception time window.

In other implementations of the disclosure, the uplink control plane message reception time window length includes a length of the updated uplink control plane message reception time window, or an offset value of the length of the updated uplink control plane message reception time window relative to a length of the configured uplink control plane message reception time window.

In other implementations of the disclosure, the downlink control plane message reception time window information includes a downlink control plane message reception time window offset and a downlink control plane message reception time window length.

In other implementations of the disclosure, the downlink control plane message reception time window offset includes an ending time of the updated downlink control plane message reception time window, or an offset value of the ending time of the updated downlink control plane message reception time window relative to an ending time of the configured downlink control plane message reception time window.

In other implementations of the disclosure, the downlink control plane message reception time window length includes a length of the updated downlink control plane message reception time window, or an offset value of the length of the updated downlink control plane message reception time window relative to a length of the configured downlink control plane message reception time window.

In other implementations of the disclosure, the downlink user plane message reception time window information includes a downlink user plane message reception time window offset and a downlink user plane message reception time window length.

In other implementations of the disclosure, the downlink user plane message reception time window offset includes an ending time of the updated downlink user plane message reception time window, or an offset value of the ending time of the updated downlink user plane message reception time window relative to an ending time of the configured downlink user plane message reception time window.

In other implementations of the disclosure, the downlink user plane message reception time window length includes a length of the updated downlink user plane message reception time window, or an offset value of the length of the updated downlink user plane message reception time window relative to a length of the configured downlink user plane message reception time window.

In other implementations of the disclosure, the second control information includes second indication information for indicating whether to update the reception time window, and the updating a reception time window of a control plane message or a user plane message based on second control information includes updating the reception time window of the message according to the second indication information for indicating whether to update the reception time window, the message includes the control plane message or the user plane message.

In other implementations of the disclosure, the second indication information includes a second information section extension, and the second information section extension includes at least one of the following extension fields an eighth extension field for indicating the control plane message reception time window offset, a ninth extension field for indicating the control plane message reception time window length, a tenth extension field for indicating the user plane message reception time window offset, and an eleventh extension field for indicating the user plane message reception time window length.

In other implementations of the disclosure, the eighth extension field is used for indicating the ending time of the uplink or downlink control plane message reception time window.

Optionally, if an indication value of the eighth extension field is 0, the ending time of the control plane message reception time window is not updated.

Optionally, if the indication value of the eighth extension field is not 0, the ending time of the control plane message reception time window is updated as the configured control plane message reception time window offset.

In other implementations of the disclosure, the eighth extension field is used for indicating an offset of the ending time of the uplink or downlink control plane message reception time window.

Optionally, if the indication value of the eighth extension field is 0, the ending time of the control plane message reception time window is not updated.

Optionally, if the indication value of the eighth extension field is not 0, the ending time of the control plane message reception time window is updated as the ending time of the configured control plane message reception time window plus the offset indicated by the eighth extension field.

In other implementations of the disclosure, the ninth extension field is used for indicating a length of the reception time window corresponding to the updated uplink or downlink control plane message.

Optionally, if an indication value of the ninth extension field is 0, a size of the control plane message reception time window is not updated.

Optionally, if the indication value of the ninth extension field is not 0, a size of the control plane message reception time window is updated as the control plane message reception time window length indicated by the ninth extension field.

In other implementations of the disclosure, the ninth extension field is used for indicating an offset value of a length of the updated control plane message reception time window relative to a length of the configured control plane message reception time window.

Optionally, if the indication value of the ninth extension field is 0, the control plane message reception time window length is not updated.

Optionally, if the indication value of the ninth extension field is not 0, the control plane message reception time window length is updated as the configured control plane message reception time window plus the offset value indicated by the ninth extension field.

In other implementations of the disclosure, the tenth extension field is used for indicating the ending time of the updated downlink user plane message reception time window.

Optionally, if an indication value of the tenth extension field is 0, the ending time of the user plane message reception time window is not updated.

Optionally, if the indication value of the tenth extension field is not 0, the ending time of the user plane message reception time window is updated as an ending time of the configured user plane message reception time window.

In other implementations of the disclosure, the tenth extension field is used for indicating an offset value of an ending time of the updated user plane message reception time window relative to the ending time of the configured user plane message reception time window.

Optionally, if the indication value of the tenth extension field is 0, the ending time of the user plane message reception time window is not updated.

Optionally, if the indication value of the tenth extension field is not 0, the ending time of the user plane message reception time window is updated as the ending time of the configured user plane message reception time window plus the offset indicated by the tenth extension field.

In other implementations of the disclosure, the eleventh extension field is used for indicating the length of the updated downlink user plane message reception time window.

Optionally, if an indication value of the eleventh extension field is 0, the user plane message reception time window length is not updated.

Optionally, if the indication value of the eleventh extension field is not 0, a size of the user plane message reception time window is updated as the user plane message reception time window length indicated by the eleventh extension field.

In other implementations of the disclosure, the eleventh extension field is used for indicating an offset value of the length of the updated user plane message reception time window relative to the length of the configured downlink user plane message reception time window.

Optionally, if the indication value of the eleventh extension field is 0, the user plane message reception time window length is not updated.

Optionally, if the indication value of the eleventh extension field is not 0, the user plane message reception time window length is updated as the configured user plane message reception time window plus the offset value indicated by the eleventh extension field.

In other implementations of the disclosure, the method further includes feeding back, according to the cached control plane information feedback indication information, information for indicating that a recovery state of the cached control plane information is SUCCESSFUL or FAILED.

In other implementations of the disclosure, the method further includes reporting capability information to the O-DU, the capability information being used for indicating at least one of the following capabilities of the O-RU
a capability to support the periodic or repeated transmission of the signal or not, a capability to cache the message, and a capability to update the reception time window.

In other implementations of the disclosure, the capability to cache the message is used for indicating a capability to cache the user plane and/or control plane messages that can be provided by the O-DU.

In other implementations of the disclosure, the capability to cache the message includes information for indicating memory size for caching the message that can be provided by the O-DU.

In other implementations of the disclosure, the capability to cache the message further includes information for indicating the number of cached messages that can be provided by the O-DU. The messages includes the control plane message and/or the user plane message.

In other implementations of the disclosure, the capability to cache the message indicates, through 1 bit or 2 bits, whether the O-RU has the capability to support the caching of the control plane message and/or the user plane message.

In other implementations of the disclosure, the capability to update the reception time window is used for indicating a capability to update the reception time window that can be provided.

In accordance with another aspect of the disclosure, an open radio access network (O-RAN) radio unit (O-RU) is provided. The O-RU includes a transceiver, memory, including one or more storage media, storing instructions, and at least one processor communicatively coupled to the transceiver and the memory, wherein the instructions, when executed by the at least one processor individually or collectively, cause the O-RU to cache first control information for a signal transmitted periodically or repeatedly, and perform subsequent transmission based on the cached first control information.

In some implementations of the disclosure, the method further includes transmitting second control information to the O-RU, to instruct the O-RU to update a reception time window of a control plane message or user plane message.

In some implementations of the disclosure, the method further includes if the received first feedback message is acknowledgement information, for data to be transmitted that corresponds to the first control information, not transmitting the corresponding control information to the O-RU.

In other implementations of the disclosure, the first control information includes first indication information for indicating whether to cache the first control information.

In other implementations of the disclosure, the first indication information of the first control information includes a first information section extension, and the first information section extension includes at least one of the following extension fields a first extension field for indicating a section corresponding to the first control information, a second extension field for indicating activation or deactivation of caching the first control information, and a third extension field for indicating the remaining number of transmissions of the signal or channel.

In other implementations of the disclosure, the first information section extension further includes a fourth extension field for indicating whether the O-RU caches data to be transmitted that corresponds to the section.

In other implementations of the disclosure, if the second extension field is used for indicating the activation of caching the first control information, the indication value of the third extension field is 0, and the first information section extension further includes a fifth extension field for indicating a transmission period of the signal or channel.

In other implementations of the disclosure, if the second extension field is used for indicating the activation of caching the first control information, the indication value of the third extension field is not 0, and the first information section extension further includes a sixth extension field for indicating a time-domain starting position of each repeated transmission of the signal or channel.

In other implementations of the disclosure, the extension fields in the first information section extension further includes a seventh extension field for indicating the number of sections to be stopped.

In other implementations of the disclosure, if an indication value of the seventh extension field is 0 for indicating that all sections in the O-RU stop to be transmitted, the first control information is all the cached control information, and if the indication value of the seventh extension field is not 0, the first control information is control information corresponding to the section indicated by the first extension field in the cached control information, wherein the number of the first extension field is the same as the indication value of the seventh extension field.

In other embodiments of the disclosure, the first control information further includes cached control plane information feedback indication information for indicating whether to feed back a recovery state of the cached control plane information, and the method further includes receiving first information or second information transmitted by the O-RU, wherein the first information is used for indicating a recovery state of each piece of the cached control plane information as SUCCESSFUL, and the second information indicates the recovery state of each piece of the cached control plane information as FAILED.

In other embodiments of the disclosure, the cached control plane information feedback indication information is statically configured, fed back and indicated through a management plane, or dynamically fed back and indicated through a control plane.

In other implementations of the disclosure, the method further includes receiving information for indicating the recovery state of the cached control plane information as SUCCESSFUL or FAILED transmitted by the O-RU.

In other implementations of the disclosure, the method further includes receiving a second feedback message for caching the data to be transmitted that corresponds to the first control information transmitted by the O-RU.

In other implementations of the disclosure, the method further includes, if at least one of the following is satisfied, for the data to be transmitted that corresponds to the first control information, continuously transmitting the corresponding control information to the O-RU from a next period or next transmission, the received first feedback message is non-acknowledgement information, the first feedback message is not received within a predetermined period of time, and the received second feedback message is non-acknowledgement information.

In other implementations of the disclosure, according to states of the control plane message and the user plane message cached by the O-RU, the second control information is transmitted to the O-RU to instruct the O-RU to perform time window adjustment based on the second control information and use a new time window to receive the messages.

In other implementations of the disclosure, the second control information includes control plane message reception time window information and user plane message reception time window information.

In other implementations of the disclosure, the control plane message reception time window information includes uplink control plane message reception time window information, and/or downlink control plane message reception time window information.

In other implementations of the disclosure, the user plane message reception time window information includes downlink user plane message reception time window information.

In other implementations of the disclosure, the uplink control plane message reception time window information includes an uplink control plane message reception time window offset and an uplink control plane message reception time window length.

In other implementations of the disclosure, the uplink control plane message reception time window offset includes an ending time of the updated uplink control plane message reception time window, or an offset value of the ending time of the updated uplink control plane message reception time window relative to an ending time of the configured uplink control plane message reception time window.

In other implementations of the disclosure, the uplink control plane message reception time window length includes a length of the updated uplink control plane message reception time window, or an offset value of the length of the updated uplink control plane message reception time window relative to a length of the configured uplink control plane message reception time window.

In other implementations of the disclosure, the downlink control plane message reception time window information includes a downlink control plane message reception time window offset and a downlink control plane message reception time window length.

In other implementations of the disclosure, the downlink control plane message reception time window offset includes an ending time of the updated downlink control plane message reception time window, or an offset value of the ending time of the updated downlink control plane message reception time window relative to an ending time of the configured downlink control plane message reception time window.

In other implementations of the disclosure, the downlink control plane message reception time window length includes a length of the updated downlink control plane message reception time window, or an offset value of the length of the updated downlink control plane message reception time window relative to a length of the configured downlink control plane message reception time window.

In other implementations of the disclosure, the downlink user plane message reception time window information includes a downlink user plane message reception time window offset and a downlink user plane message reception time window length.

In other implementations of the disclosure, the downlink user plane message reception time window offset includes an ending time of the updated downlink user plane message reception time window, or an offset value of the ending time of the updated downlink user plane message reception time window relative to an ending time of the configured downlink user plane message reception time window.

In other implementations of the disclosure, the downlink user plane message reception time window length includes a length of the updated downlink user plane message reception time window, or an offset value of the length of the updated downlink user plane message reception time window relative to a length of the configured downlink user plane message reception time window.

In some implementations of the disclosure, the second control information includes second indication information for indicating whether to update the reception time window.

In other implementations of the disclosure, the second indication information of the second control information includes a second information section extension, and the second information section extension includes at least one of the following extension fields an eighth extension field for indicating the control plane message reception time window offset, a ninth extension field for indicating the control plane message reception time window length, a tenth extension field for indicating the user plane message reception time window offset, and an eleventh extension field for indicating the user plane message reception time window length.

In other implementations of the disclosure, the eighth extension field is used for indicating an ending time of the reception time window corresponding to the updated uplink and/or downlink control plane message.

In other implementations of the disclosure, the eighth extension field is used for indicating an offset of the ending time of the reception time window corresponding to the uplink or downlink control plane message relative to an ending time of the reception time window corresponding to the configured uplink or downlink control plane message.

In other implementations of the disclosure, the ninth extension field is used for indicating a length of the reception time window corresponding to the updated uplink or downlink control plane message.

In other implementations of the disclosure, the ninth extension field is used for indicating an offset value of a length of the updated uplink or downlink control plane message reception time window relative to a length of the configured control plane message reception time window.

In other implementations of the disclosure, the tenth extension field is used for indicating the ending time of the reception time window corresponding to the updated downlink user plane message.

In other implementations of the disclosure, the tenth extension field is used for indicating an offset value of an ending time of the downlink user plane message reception time window relative to an ending time of the configured user plane message reception time window.

In other implementations of the disclosure, the eleventh extension field is used for indicating the length of the updated downlink user plane message reception time window.

In other implementations of the disclosure, the eleventh extension field is used for indicating an offset value of the length of the updated downlink user plane message reception time window relative to a length of the configured downlink user plane message reception time window.

In other implementations of the disclosure, the method further includes receiving capability information reported by the O-RU, the capability information being used for indicating at least one of the following capabilities of the O-RU a capability to support the periodic or repeated transmission of the signal or not, a capability to cache the message, and a capability to update the reception time window.

In accordance with another aspect of the disclosure, an electronic device is provided. The electronic device includes a processor, and memory configured to store machine-readable instructions, that when executed by the processor, cause the processor to perform the communication method for an open radio access network (O-RAN) described in the first aspect or second aspect of the disclosure.

Optionally, the electronic device is an O-RAN distributed unit (O-DU), and the processor can perform the communication method performed by the O-DU according to any optional embodiment of the disclosure when running the computer program.

Optionally, the electronic device is an O-RAN radio unit (O-RU), and the processor can perform the communication method performed by the O-RU according to any optional embodiment of the disclosure when running the computer program.

In a fourth aspect, there is provided a computer-readable storage medium having stored thereon a computer program, that when executed by a processor, implements the communication method for an open radio access network (O-RAN) described in the first aspect or second aspect of the disclosure.

The technical schemes provided by the disclosure have the following beneficial effects.

For a channel or signal transmitted periodically or repeatedly, the O-RU performs subsequent transmission based on the cached control information, thus avoiding the repeated transmission of the control information, effectively reducing the message load on a fronthaul interface and improving the resource utilization.

In accordance with another aspect of the disclosure, one or more non-transitory computer-readable storage media storing one or more computer programs including computer-executable instruction that, when executed by one or more processors of an open radio access network (O-RAN) radio unit (O-RU) individually or collectively, cause the O-RU to perform operations are provided. The operations include caching first control information for a signal transmitted periodically or repeatedly, and performing subsequent transmission based on the cached first control information.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic diagram of a reference architecture of a next generation Node B (gNB)/evolved Node B (eNB) in an O-RAN according to an embodiment of the disclosure;

FIG. 2A is a flowchart of real-time control of downlink transmission of air interface data through a control plane message according to an embodiment of the disclosure;

FIG. 2B is a flowchart of real-time control of uplink transmission of air interface data through a control plane message according to an embodiment of the disclosure;

FIG. 3 is a schematic structure diagram of a control plane message according to an embodiment of the disclosure;

FIG. 4 is a schematic diagram of a transmission/reception time window in an O-RAN according to an embodiment of the disclosure;

FIG. 5 is a first schematic diagram of transmitting a control plane message and a user plane message according to an embodiment of the disclosure;

FIG. 6 is a second schematic diagram of transmitting a control plane message and a user plane message according to an embodiment of the disclosure;

FIG. 7 is a flowchart of a communication method for an open radio access network (O-RAN) according to an embodiment of the disclosure;

FIG. 8 is a flowchart of a communication method for an O-RAN according to an embodiment of the disclosure;

FIG. 9 is a first flowchart of a communication method for an O-RAN according to an embodiment of the disclosure;

FIG. 10 is a second flowchart of a communication method for an O-RAN according to an embodiment of the disclosure;

FIG. 11 is a third flowchart of a communication method for an O-RAN according to an embodiment of the disclosure;

FIG. 12 is a fourth flowchart of a communication method for an O-RAN according to an embodiment of the disclosure;

FIG. 13 is a fifth flowchart of a communication method for an O-RAN according to an embodiment of the disclosure;

FIG. 14 is a sixth flowchart of a communication method for an O-RAN according to an embodiment of the disclosure;

FIG. 15 is a schematic diagram of adjustment of a time window for an open radio access network (O-RAN) according to an embodiment of the disclosure; and

FIG. 16 is a schematic structure diagram of an electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a”, “an”, and “the” include plural referents unless the context clearly dictates otherwise. Thus, for example, reference to “a component surface” includes reference to one or more of such surfaces.

It should be further understood that the word “comprise” used in the specification of the disclosure specifies the presence of the stated features, integers, steps, operations, elements and/or components, but does not exclude the presence or addition of one or more other features, integers, steps, operations, elements, components and/or combinations thereof. It should be understood that, when an element is referred to as being “connected” or “coupled” to another element, it can be directly connected or coupled to the other element or intervening elements may also be present. In addition, the “connection” or “coupling” as used herein may include wireless connection or coupling. As used herein, the word “and/or” includes all or any of one or more of the associated listed items or combinations thereof.

The 5th-Generation (5G) mobile communication technology has been gradually standardized, and its three application scenarios mainly include ultra-reliable and low latency communication (URLLC), enhanced mobile broadband (eMBB), and massive machine type communication (mMTC). However, with the application and development of 5G, more and more devices and mobile data are connected to the 5G system, and the radio access network (RAN) has the problems of increasing traffics, high investment cost, insufficient flexibility and the like. In view of these problems, operators expect to realize faster innovation and higher flexibility, reduce device cost and realize higher performance by opening up the standardization of third-party devices.

In this case, the open radio access network (O-RAN) standard has emerged. The O-RAN allows interoperations among network devices from different suppliers, and a standardized interface becomes more open and has more flexible functions. Meantime, the introduction of machine learning and artificial intelligence will bring new opportunities to the O-RAN and accelerate the speed of innovation. An open and intelligent radio access network is advantageous for reducing the device cost, stimulating innovation and promoting the application of various new fields in the market faster.

In a basic architecture of the O-RAN, a fronthaul interface (FH IF) between an O-RAN distributed unit (O-DU) and an O-RAN radio unit (O-RU) is an open network. The transmission latency must be strictly required on limited bandwidth resources, and an effective reduction of the load on the fronthaul interface also needs to be considered and optimized in the O-RAN. At present, an optimization of the fronthaul load in the O-RAN is mainly as follows: the user plane adopts various compression algorithms to reduce the number of bits required to transmit the same data, and the control plane reduces the number of bits of transmitted control message by various extensions. However, the existing implementation schemes do not consider the periodic and repeated transmission characteristics of 5G. By optimizing the fronthaul interface based on these transmission characteristics, the number of transmissions of the user plane message and the control plane message can be reduced, the fronthaul load can be further reduced, and the reliability and stability of transmission can be improved.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

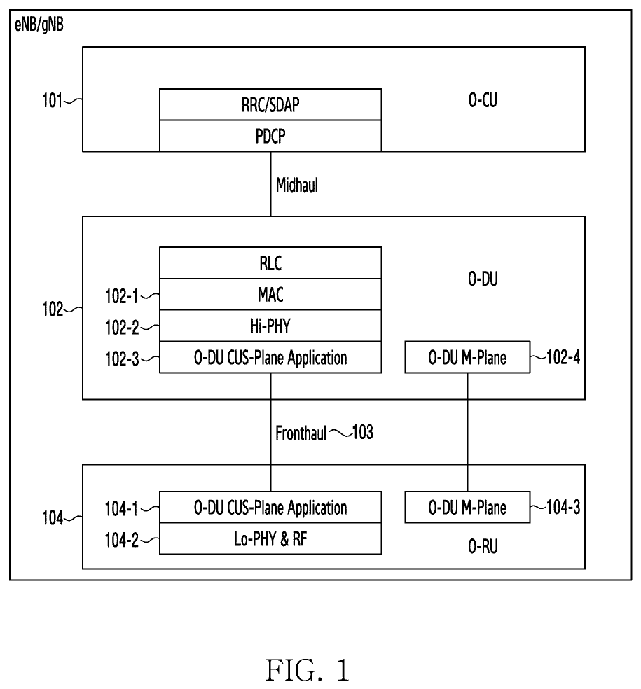

FIGS. 1, 2A, 2B, 3, 4, 5, 6, 7, 8, 9, 10, 11, and 12, discussed below, and the various embodiments used to describe the principles of the disclosure in this patent document are by way of illustration only and should not be construed in any way to limit the scope of the disclosure. Those skilled in the art will understand that the principles of the disclosure may be implemented in any suitably arranged system or device.

FIG. 1 is a schematic diagram of a reference architecture of a gNB/eNB in an O-RAN according to an embodiment of the disclosure.

Referring to FIG. 1, it illustrates the reference architecture of the base station in the O-RAN. In the figure, the base station may be a next generation Node B (gNB, NR base station) that supports the 5G new radio (NR) standard, or may also be an evolved Node B (eNB, long term evolution (LTE) base station) that supports 4th generation (4G) long term evolution (LTE). The reference architectures of the gNB and the eNB are slightly different, but it has no influence on the content of the disclosure, so the gNB and the eNB are not distinguished. Other functional entities except for the base station in the O-RAN as well as the interfaces between these functional entities and the base station are not involved in the disclosure, so they are also not illustrated in the drawings. The specific modules in the reference architecture of the O-RAN will be described below, and the irrelevant modules will not be described further.

101 O-RAN central unit (O-CU): it is a logic node that includes an O-RAN central unit-control plane (O-CU-CP) and an O-RAN central unit-user plane (O-CU-UP). The O-CU-CP is a logic node that includes control plane parts of radio resource control (RRC) and packet data convergence protocol (PDCP), and the O-CU-UP is a logic node that includes user plane parts of service data adaptation protocol (SDAP) and PDCP.

102 O-RAN distributed unit (O-DU): it is a logic node that is based on lower layer functional split and includes a radio link control (RLC) layer, a media access control (MAC) layer and a high physical layer (high-PHY).

102-1 MAC: it is a 3GPP functional layer, and is mainly responsible for mapping of logic channels and transport channels. It reuses an MAC service data unit (SDU) from one or more different logic channels to transport blocks (TBs) so as to transmit to physical layers on the transport channels, and can also reuse the MAC SDU from the TBs transported by the transport channels to the one or more different logic channels. It also supports scheduling information reporting, for example, error correction through a hybrid automatic repeat request (HARQ), data transmission according to priorities of the logic channels and other functions.

102-2 High-PHY: it has the functions of physical layer processing on the O-DU side of the fronthaul interface after the physical layer of the 3GPP functional layer is split, including forward error correction encoding/decoding, channel estimation, modulation/demodulation, scrambling/descrambling, and so on.

102-3 O-DU control, user, synchronization plane application (O-DU CUS-Plane Application, simply referred to as O-DU application herein): it is an O-DU logic function, and is responsible for creating and transmitting messages of a control-plane (C-Plane), a user-plane (U-Plane) and a synchronization-plane (S-Plane) to an O-RAN radio unit (O-RU) or receiving the messages from the O-RU on the fronthaul interface. The control plane refers to real-time control information between the O-DU and the O-RU. The control plane message carries relevant information (such as scheduling, coordination and other information required for data transmission, beamforming or the like) for controlling the user plane message, the user plane message carries time-frequency domain In-phase/Quadrature (I/Q) data transmitted between the O-DU and the O-RU, and the synchronization plane message is used for realizing timing and time-frequency synchronization between the O-DU and the O-RU. The CUS-Plane (C-Plane, U-plane and S-Plane) is transmitted in real time on the fronthaul interface between the O-DU and the O-RU according to the data scheduling.

102-4 O-DU management plane (O-DU M-Plane): it is an O-DU logic function, and refers to a non-real-time management operation between the O-DU and the O-RU, including initialization of the O-RU based on a network configuration/yet another next generation (NETCONF/YANG) data modeling language, software management, configuration management, performance management, fault management, file management or the like. The configuration of the management-plane (M-Plane) is generally relatively static.

103 O-RAN open fronthaul interface (OFH I/F): the fronthaul is a logic link that connects the O-DU with the O-RU, and is responsible for transmitting information of the control plane, the user plane, the synchronization plane and the management plane. The FH IF incudes a CUS-Plane interface and an M-Plane interface, and is an interface based on the enhanced common public radio interface (eCPRI) or the Institute of Electrical and Electronics Engineers (IEEE).

104 O-RAN radio unit (O-RU): it is a logic node based on the lower layer functional split, and carries the low physical layer (low-PHY) and the radio frequency (RF) processing.

104-1 O-RU control, user, synchronization plane application (O-RU CUS-Plane Application, simply referred to as O-RU application herein): it is an O-RU logic function, and is responsible for transmitting messages of the C-Plane, the U-Plane and the S-Plane to the O-DU or receiving and processing the messages from the O-DU on the fronthaul interface.

104-2 Low-PHY: it has a function of processing on the O-RU side of the fronthaul interface after the physical layer of the 3GPP functional layer is split, and it is responsible for fast Fourier transformation/inverse fast Fourier transformation (FFT/IFFT), analog beamforming, digital beamforming, digital-to-analog/analog-to-digital conversion and other functions.

104-3 O-RU management plane (O-RU M-Plane): it is an O-RU logic function, accepts the management of the O-DU M-Plane, and performs capability reporting to the O-DU in an initialization stage to notify the O-DU of what optional capabilities that the O-RU supports.

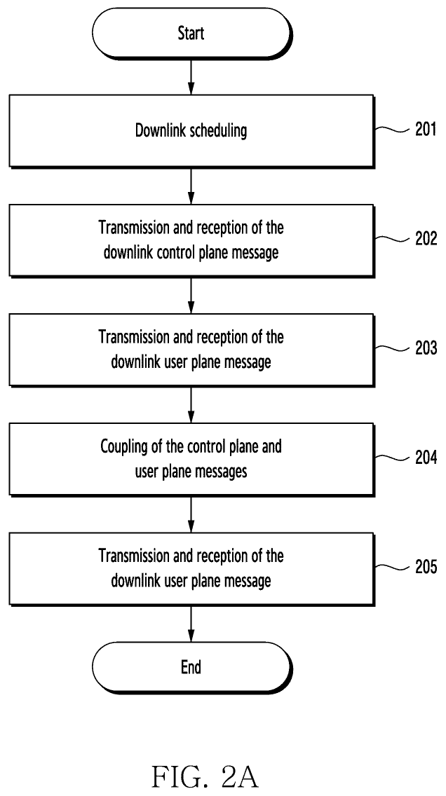

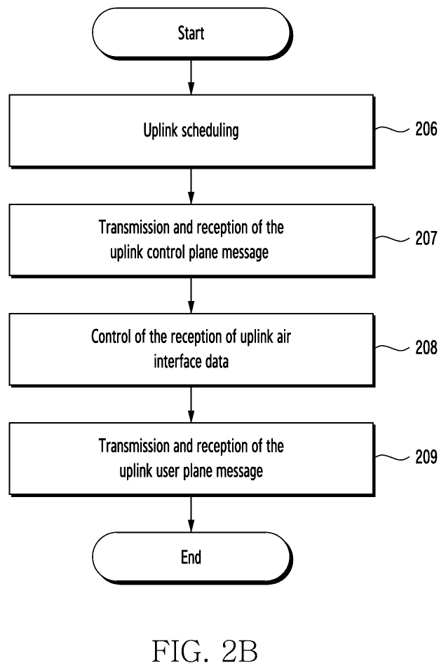

FIGS. 2A, 2B, 3, 4, and 5, discussed below, and the various embodiments used to describe the principles of the disclosure in this patent document are by way of illustration only and should not be construed in any way to limit the scope of the disclosure. Those skilled in the art will understand that the principles of the disclosure may be implemented in any suitably arranged system or device.

In the method for controlling transmission and reception of air interface data in real-time based on the control plane message, there are different processes for downlink and uplink.

FIG. 2A is a process of processing downlink data according to an embodiment of the disclosure.

Referring to FIG. 2A, operation 201 is downlink scheduling. This operation is performed in the O-DU, specifically in the 102-1 MAC scheduler. After completing the downlink scheduling, the MAC scheduler will transmit the result of downlink scheduling to the High-PHY for modulation and encoding, and will also transmit the result of downlink scheduling to the 102-3 O-DU application for the creation of the control plane message and the user plane message. The result of downlink scheduling has the minimum time-domain granularity of orthogonal frequency division multiplexing (OFDM) symbol and the minimum frequency-domain granularity of resource element (RE, which occupies one OFDM symbol in the time domain and occupies one subcarrier in the frequency domain). The result of downlink scheduling includes but is not limited to time-domain and frequency-domain resource allocation information of physical downlink shared channels (PDSCHs), physical downlink control channels (PDCCHs), channel state information-reference signals (CSI-RSs), beam index and the like.

Operation 202 is the transmission and reception of a downlink control plane message. This operation is performed in the O-DU and the O-RU, specifically in the 102-3 O-DU application, the 103 FH I/F and the 104-1 O-RU application. The O-DU application creates a control plane message for controlling the transmission of downlink air interface data according to the result of downlink scheduling of the operation 201, and transmits it to the O-RU application through the FH I/F. This control plane message mainly indicates OFDM symbol, physical resource block (PRB, which consists of REs), REs, beam index, IFFT parameter and other information. The O-RU application receives the control plane message, and obtains, from the control plane message, the information of each field of the transport layer and the application layer.

Operation 203 is the transmission and reception of a downlink user plane message. This operation is performed in the O-DU and the O-RU, specifically in the 102-3 O-DU application, the 103 FH I/F and the 104-1 O-RU application. The O-DU application creates the modulated and encoded I/Q data output by the High-PHY as the downlink user plane message, and transmits it to the O-RU application through the FH I/F. This user plane message mainly carries the I/Q data carried on each RE in the specified OFDM symbol and PRB. The O-RU application receives the user plane message, and obtains, from the user plane message, the information of each field of the transport layer and the application layer and the I/Q data.

Operation 204 is the coupling of the control plane/user plane message. This operation is performed in the O-RU, specifically in the 104-1 O-RU application. Since the control plane message and the user plane message are transmitted separately, it is necessary to perform the coupling on the section description in the control plane message and the data section in the user plane message. A basic coupling method is coupling based on a section index (sectionID). In addition, in order to reduce the number of the section description in the control plane message, coupling based on time-frequency resources, coupling based on time-frequency resources with priorities and other coupling methods are also proposed.

Operation 205 is the control of the transmission of downlink air interface data. This operation is performed in the O-RU, specifically in the 104-1 O-RU application and the 104-2 Low-PHY. After completing the coupling, the O-RU delivers the coupled section description and data section to the Low-PHY. The Low-PHY processes the coupled section description and data section, and performs digital beamforming, inverse fast Fourier transformation (IFFT), analog beamforming and other processing on the downlink data section according to the control information indicated in the section description.

FIG. 2B is a process of processing uplink data according to an embodiment of the disclosure.

Referring to FIG. 2B, operation 206 is uplink scheduling. This operation is performed in the O-DU, specifically in the 102-1 MAC scheduler. After completing the uplink scheduling, the MAC scheduler will transmit the result of uplink scheduling to the High-PHY for decoding and demodulation after receiving user plane data from the O-RU, and will also transmit the result of uplink scheduling to the O-DU application for the creation of the control plane message. The result of uplink scheduling has the minimum time-domain granularity of OFDM symbol and the minimum frequency-domain granularity of RE. The result of uplink scheduling includes but is not limited to time-domain and frequency-domain resource allocation information of physical uplink shared channels (PUSCHs), physical uplink control channels (PUCCHs), sounding reference signals (SRSs) and physical random access channels (PRACHs), beam index and the like.

Operation 207 is the transmission and reception of the uplink control plane message. This operation is performed in the O-DU and the O-RU, specifically in the 102-3 O-DU application, the 103 FH I/F and the 104-1 O-RU application. The O-DU application creates a control plane message for controlling the reception of uplink air interface data according to the result of scheduling of the operation 206, and transmits it to the O-RU application through the FH I/F. This control plane message mainly indicates the OFDM symbol, PRB, REs, beam index, IFFT parameter and other information. The O-RU application receives the control plane message, and obtains, from the control plane message, the information of each field of the transport layer and the application layer.

Operation 208 is the control of the reception of uplink air interface data. This operation is performed in the O-RU, specifically in the 104-1 O-RU application and the 104-2 Low-PHY. The O-RU application indicates the control information carried by the section description extracted from the control plane message to the Low-PHY. The Low-PHY performs analog beamforming, FFT, digital beamforming and other processing on the uplink air interface data according to the control information, and delivers the processed I/Q data to the O-RU application.

Operation 209 is the transmission and reception of an uplink user plane message. This operation is performed in the O-RU and the O-DU, specifically in the 104-1 O-RU application, the 103 FH I/F and the 102-3 O-DU application. The O-RU application creates the I/Q data output from the Low-PHY as the uplink user plane message, and transmits it to the O-DU application through the FH I/F. This user plane message mainly carries the I/Q data carried on each RE in the specified OFDM symbol and PRB. The O-DU application receives the user plane message, obtains, from the user plane message, the I/Q data carried on each RE in the specified OFDM symbol and PRB, and delivers the I/Q data to the High-PHY for subsequent decoding and demodulation.

Each piece of control plane message in FIGS. 2A and 2B belongs to a certain endpoint (this endpoint may be a transmission endpoint low-level-tx-endpoint corresponding to downlink or a reception endpoint low-level-rx-endpoint corresponding to uplink). Each endpoint is allocated with a unique extended antenna-carrier identifier or index (eAxC ID). This identifier or index is carried in the transport header of the control plane message and the user plane message and used by the O-RU and the O-DU to distinguish which endpoint this message belongs to.

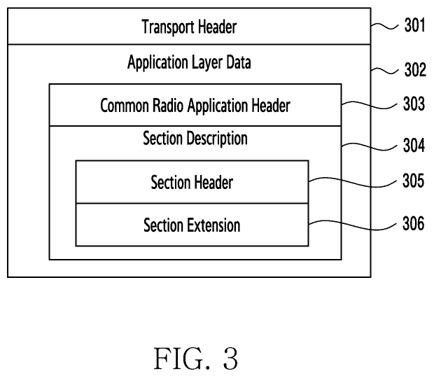

FIG. 3 is a schematic structure diagram of a control plane message according to an embodiment of the disclosure.

Referring to FIG. 3, he eAxC ID is classified into ecpriRtcID and ecpriPcID, where the ecpriRtcID (real time control data identifier) is used to identify the data flow related to the control plane message. The transport layer structure in the control plane message is as shown in FIG. 3, wherein:

301 Transport header: it may be an enhanced common public radio interface (eCPRI) header and a radio over Ethernet (ROE) header, including corresponding fields for indicating the message type, such as eAxC ID and other information.

302 Application layer data: it includes necessary fields used for control and synchronization, i.e., transport layer payload.

303 Common radio application header: It includes data direction, payload version, filter index, frameID, subframeID, slotID, start symbolID, number of sections, section type and other information.

304 Section description: it describes the control information, and includes the information for controlling the transmission or reception of the user plane message. One control plane message may include a plurality of section descriptions.

305 Section header: it includes the section index (sectionID), the symbol increment mark (symInc), the number of symbols (numSymbol), frequency-domain resource information (such as the start PRB (startPrbc) of the section description, the number of continuous PRBs in the section description (numPrbc), and the number of symbols (numSymobol)), the beam index (beamID), the extension identifier (ef) and other information.

306 Section extension: it describes the control information except for the information included in the section header. One section description may include a plurality of section extensions. If the value of the extension identifier ef is 1, it indicates that there are other section extensions after this section extension.

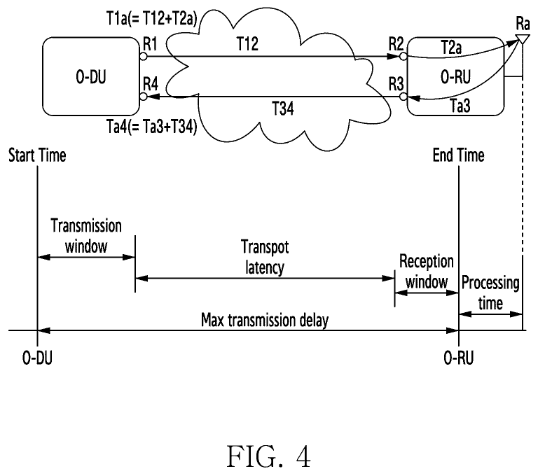

FIG. 4 is a schematic diagram of a transmission/reception time window in an O-RAN according to an embodiment of the disclosure.

Referring to FIG. 4, in order to ensure the synchronization of the transmission/reception of uplink or downlink data between a UE and a base station unit, the reference point Ra needs to perform the transmission of downlink data and the reception of uplink data in a predefined time T (see FIG. 4). The O-RAN defines a plurality of time intervals and time windows:
T12: the transmission time of downlink data from the O-DU to the O-RU through the fronthaul interface, where the maximum T12 and the minimum T12 are downlink propagation latencies.
T2a: a time interval in which the O-RU receives downlink data from the O-DU, then performs L-PHY processing and transmits the downlink data through the reference point Ra.
T1a: a time interval of downlink data from the O-DU to the reference point Ra, which is equal to the sum of T12 and T2a.
Ta3: a time interval in which uplink data transmitted by the UE is received by the O-RU through the reference point Ra and subjected to uplink L-PHY processing.
T34: a transmission time interval of uplink data from the O-RU to the O-DU through the fronthaul interface, where the maximum T34 and the minimum T34 are uplink propagation latencies.
Ta4: a time interval of uplink data from the reference point Ra to the O-DU, which is equal to the sum of Ta3 and T34.

Further, the O-RAN regulates the reception time window and the transmission time window to restrict the O-RU/O-DU's requirements for the transmission of uplink and downlink data and the transmission time point.

Transmission time window: it is a time window for transmitting fronthaul data. The O-DU must transmit downlink data to the O-RU in the transmission time window, and the O-RU must transmit uplink data to the O-DU in the transmission time window.

Reception time window: it is a window for indicating data reception. The O-RU will receive the downlink data transmitted by the O-DU in the downlink reception time window, and the O-DU will receive the uplink data transmitted by the O-RU in the uplink reception time window.

| | Reception window | Transmission window |
|---|---|---|
| Downlink | T2a_max-T2a_min | T1a_max-T1a_min |
| Uplink | Ta4_max-Ta4_min | Ta3_max-Ta3_min |

It is to be noted that, in the embodiments of the disclosure, the reception time window can also be described as a reception window, and the transmission time window can also be described as a transmission window or a transmission time window, which will not be limited here.

In the O-RAN, for periodic/repeated transmission, the following two methods are generally used:
1. The control plane message and user plane message are transmitted one by one.
2. For the periodic signal transmission, the time-domain and frequency-domain information is preconfigured through a management plane to periodically transmit or receive the user plane message.

In the above method 1, the periodic/repeated signal transmission is realized by transmitting the corresponding control plane message and user plane message during each transmission.

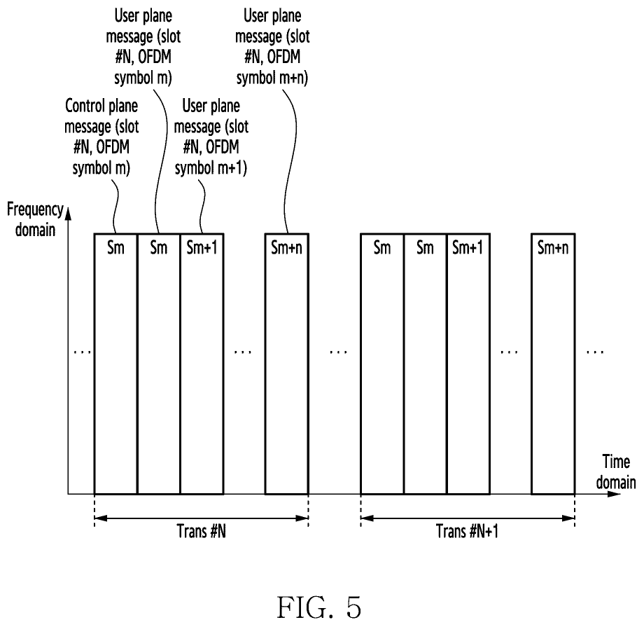

FIG. 5 is a first schematic diagram of transmitting a control plane message and a user plane message according to an embodiment of the disclosure.

Referring to FIG. 5, for each transmission, the O-DU will transmit the corresponding control plane message and user plane message in each transmission period. However, for a periodically/repeatedly transmitted signal, its time-domain and frequency-domain transmission positions are determined, and some of the periodically transmitted user plane data is also the same, so some contents of the control plane message and user plane message corresponding to each periodic/repeated signal transmission are the same. From the perspective of fronthaul load, the repeated transmission increases the load of the O-DU and the O-RU.

The method 2 is mainly applied to periodic signals, such as PRACHs and SRSs.

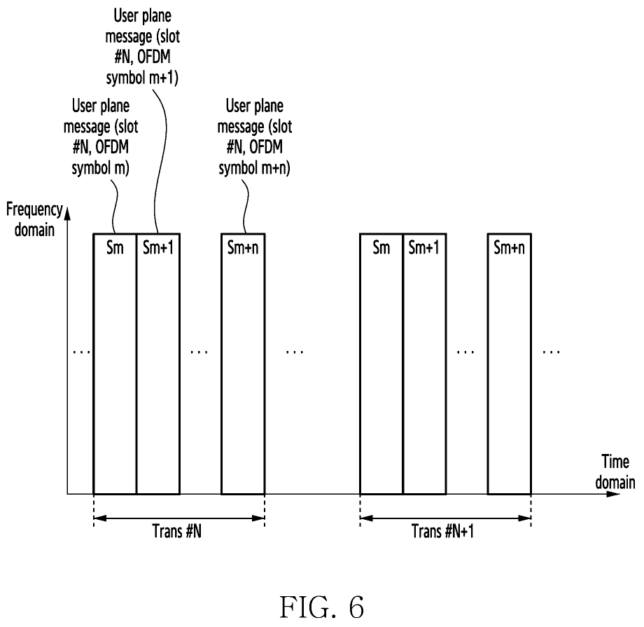

FIG. 6 is a second schematic diagram of transmitting a control plane message and a user plane message according to an embodiment of the disclosure.

Referring to FIG. 6, the time-domain and frequency-domain configuration information in the control plane message is preconfigured in the management plane, so the corresponding control plane message does not need to be transmitted during each subsequent transmission, and it is only necessary to transmit or receive the corresponding user plane message. This way can save the number of transmissions of the control plane message of the periodic signals, but cannot adapt to repeated transmission (the transmission position of repeated transmission is not necessarily periodic in the time domain). In addition, even if the I/Q data transmitted each time is the same, the O-DU also needs to repeatedly transmit the user plane message carrying these I/Q data, so that the transmission efficiency of the fronthaul port is also reduced to a certain extent. On the other hand, the method 2 adopts a static configuration mode. In order to avoid the missing of I/Q data, static reservation will be performed at every possible transmission occasion, resulting in excessive waste of resources.

Thus, a more flexible, dynamic and extensible scheme is needed to further reduce the fronthaul capacity. Therefore, the disclosure proposes a dynamic communication method. For a channel or signal whose time-domain starting position of each transmission is changed, by defining a new extension structure, the O-RU can acquire the time-domain and frequency-domain control information corresponding to each subsequent transmission based on the cached control information, thus avoiding the repeated transmission of the control information. For a user plane, if the I/Q data transmitted by the periodically transmitted channel or signal each time is the same, the O-RU will also cache the I/Q data, and the O-DU directly obtains the cached I/Q data during the subsequent transmission, without transmitting the corresponding user plane message. By this method, the O-DU can avoid the repeated transmission of the control information and corresponding I/Q data, thus effectively reducing the message load on a fronthaul interface and improving the resource utilization. Compared with the existing processing methods, the application scenario is wider, the processing is more flexible, and the reliability of data transmission can also be improved to a certain extent.

The method in the embodiments of the disclosure can be applied to channels or signals with periodic/semi-persistent characteristics (including but not limited to periodic/semi-persistent sounding reference signals (SRSs), channel state information-reference signals (CSI-RSs), cell reference signals (CRSs), synchronization signals/PBCH blocks (SSBs), and semi-persistent scheduling PDSCHs, physical uplink shared channels (PUSCHs)), can also be applied to channels or signals with repetitive characteristics (including but not limited to uplink repetitive transmission signals and downlink repetitive transmission signals), and can also be applied to channels or signals with periodic characteristics, such as uplink/downlink scheduling-free channels or signals.

In other words, the method of the disclosure is suitable for the transmission process of channels or signals whose time-domain starting position is changed during each transmission while other parameters (such as frequency domain) remain unchanged.

Further, based on the proposed method, the reception time window of the control plane/user plane message can be optimized to realize a dynamic O-RU/O-DU timing control.

The disclosure proposes the following two main inventive concepts:

First, the control plane message and/or the user plane message is dynamically transmitted and cached.

For periodic transmission where the data transmitted each time is different (e.g., PDSCH retransmission), the O-DU can only transmit the control plane message for the first time, and the O-RU caches the control plane message and uses the control plane message for the subsequent reception of the data plane message.

For periodic transmission where the data transmitted each time is the same (e.g., CSI-RS transmission), the O-DU can only transmit the control plane message and the data plane message for the first time, the O-RU caches the control plane message and the data plane message, and the O-RU directly reads the data from the cache subsequently without repeated transmission by the O-DU, thus saving fronthaul.

Second, the reception time window of the control plane message and/or the user plane message is dynamically adjusted.

After the O-RU caches the control plane message and/or the data plane message, the O-DU may adjust the size of the reception window of the message, so that the transmission latency for the downlink message is reduced, more processing time can be reserved to the O-RU, and the performance of the O-RU is improved.

A basic process of the system will be described below:
1. The O-RU reports capabilities (including a new extension field and the capability to cache messages (e.g., the memory size for caching messages that can be provided), or the like) to the O-DU, and the O-DU determines, according to the reported capabilities, whether the O-RU can support the scheme provided in the embodiments of the disclosure. If the O-RU can support the scheme, before transmitting a message each time, the O-DU will determine whether to cache the control plane message and/or the user plane message and whether to inform the O-RU to adjust the message reception time window.
2. For the message transmitted each time, the O-DU needs to determine whether the message is transmitted periodically or repeatedly. The O-DU may determine, according to the configuration information, scheduling information, signal type, DCI format and other information corresponding to the transmitted message, whether the message is transmitted periodically or repeatedly.
3. For periodic transmission or repeated transmission, if only the resource allocation or scheduling is known or predictable, the O-DU will inform the O-RU to cache the control information through the new extension field when transmitting the message for the first time, and the O-DU will not transmit the control information again subsequently.
4. If the user plane message transmitted each time that corresponds to the control plane message is also the same, the O-DU will inform the O-RU to cache the control plane message and corresponding user plane message through the new extension field when transmitting the message for the first time, and the O-RU will not transmit the control plane message and the user plane message again subsequently.
5. When transmitting the control plane message each time, the O-DU will determine, based on the number of the control plane message and user plane message cached by the O-DU, the message size and the like, whether to inform the O-RU to update the reception time window, and the O-DU will inform the O-RU of a new time window information through the new extension field when transmitting the message.
6. When the O-RU receives the control plane message with the new extension field, the O-RU determines, according to the information carried by the extension field, whether to cache the user plane message simultaneously, and caches the control plane message in the O-RU.
7. If only the control plane message is cached, the O-RU infers a next moment to receive the control plane message according to period information in the extension field, or receives the user plane message at the moment according to the next moment to receive the control plane message indicated in the extension field and then performs subsequent processing.
8. If both the control plane message and the user plane message are cached, the O-RU infers the next moment to receive the control plane message according to the period information in the extension field, or directly reads the corresponding user plane message from the memory of the O-RU for subsequent processing according to the next moment to receive the control plane message indicated in the extension field.
9. When the control plane message received by the O-RU comprises an extension field for indicating the updating of the time window, the O-RU may calculate a new reception time window, and uses the time window for subsequent reception of the control plane message or user plane message.

In the O-RAN, one signal or channel is represented by a section (slice or section), and the signal or channel described hereinafter can be interpreted as a slice or section.

The technical schemes of the disclosure and how the technical schemes of the disclosure address the above technical issues will be described below by specific embodiments. The following several specific embodiments can be combined with each other, and the same or similar concepts or processes may not be repeated in some embodiments. The embodiments of the disclosure will be described below with reference to the drawings. The text and the drawings in the following description are merely provided as examples to help readers to understand the disclosure. They are not intended to limit the scope of the disclosure in any way. Although some embodiments and examples have been provided, based on the contents disclosed herein, it is apparent to those skilled in the art that changes can be made to the illustrated embodiments and examples without departing from the scope of the disclosure.

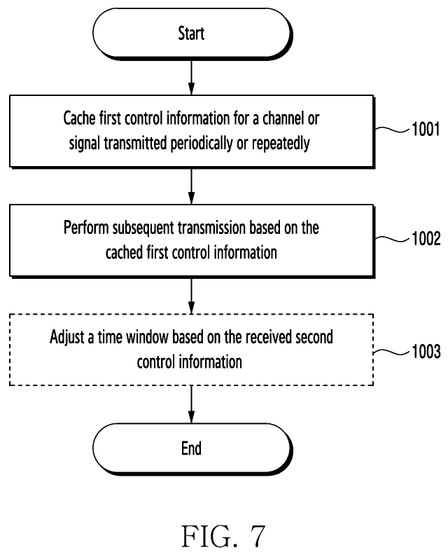

FIG. 7 is a flowchart of a communication method for an open radio access network (O-RAN) according to an embodiment of the disclosure.

Referring to FIG. 7, a communication method for an open radio access network (O-RAN) according to an embodiment of the disclosure is shown. The method is applied to an O-RAN radio unit (O-RU), and the method comprises the following operations.

In operation 1001, first control information is cached for a channel or signal transmitted periodically or repeatedly.

In operation 1002, subsequent transmission is performed based on the cached first control information.

In the embodiment of the disclosure, if the time-domain real-time position of the channel or signal during each transmission is changed while other parameters remain unchanged, the control information corresponding to each subsequent transmission may be determined based on the cached control information, thus avoiding the repeated transmission of the control information.

In some embodiments of the disclosure, the method shown in FIG. 7 may further comprise the following.

In operation 1003, a reception time window is adjusted based on the received second control information.

In the embodiment of the disclosure, if the O-RU has cached some control plane message and data plane message, the message reception time window may be updated for reception of subsequent messages based on the received time window information.

In some embodiments of the disclosure, the method further comprises:
receiving a control plane message transmitted by an O-RAN distributed unit (O-DU), the control plane message comprising at least one piece of the first control information.

In some embodiments of the disclosure, the first control information comprises first indication information for indicating whether to cache the first control information, and
the caching first control information comprises:
caching the first control information according to the first indication information for indicating whether to cache the first control information.

In some embodiments of the disclosure, the first control information may further comprise transmission resource related information.

Optionally, in the embodiment of the disclosure, the transmission resource related information may include time/frequency-domain resource information.

For a channel or signal transmitted periodically, the control information may carry time-domain starting position, period information and other time-domain information. For a channel or signal transmitted repeatedly, the control information may carry information for determining the time-domain starting position of each transmission.

In some embodiments of the disclosure, the method further comprises:
determining whether to cache data to be transmitted that corresponds to the first control information according to the first indication information; and
if it is determined to cache the data to be transmitted, caching data to be transmitted in a user plane message transmitted by the O-DU,
wherein the performing subsequent transmission based on the cached first control information comprises:
transmitting the cached data to be transmitted based on the cached first control information.

Optionally, in the embodiment of the disclosure, the data to be transmitted may include I/Q data.

If the I/Q data transmitted each time is the same, the cached I/Q data can be directly obtained during each transmission, thus avoiding the repeated transmission of the user plane message.

Optionally, in the above embodiments of the disclosure, the first indication information of the first control information comprises a first information section extension, and the first information section extension comprises at least one of the following extension fields:
a first extension field for indicating a section corresponding to the first control information, for example, which may be an ID corresponding to the section;
a second extension field for indicating activation or deactivation of caching the first control information; and
a third extension field for indicating the remaining number of transmissions of the signal or channel. In the embodiment of the disclosure, the information section extension may comprise one or more of: a first extension field for indicating the ID bound by a section index corresponding to the first control information, a second extension field for indicating the activation or deactivation of section transmission, and a third extension field for indicating the remaining number of transmissions of the signal or channel.

It is to be noted that, the first information section extension is not limited to the above extension fields and may further comprise the following extension fields: an extension identifier, an extension field for indicating the extension type, an extension field for indicating a size of the extension structure, an extension field for indicating zero padding, and so on.

In some embodiments of the disclosure, the first information section extension may further comprise:
a fourth extension field for indicating whether the O-RU caches data to be transmitted that corresponds to the section.

In some embodiments of the disclosure, if the second extension field is used for indicating the activation of caching the first control information, an indication value of the third extension field is 0, and the extension fields in the first information section extension further comprise a fifth extension field, wherein the fifth extension field is used for indicating a transmission period of the signal or channel.

In the embodiment of the disclosure, if the indication value of the third extension field for indicating the remaining number of transmissions of the signal or channel is 0, it indicates that the signal or channel is transmitted periodically, the second extension field is used for indicating the activation of caching the first control information (for example, the indication value of the second extension field is 1), and the extension fields in the first information section extension further comprise an extension field for indicating a transmission period of the signal or channel.

Optionally, in the embodiment of the disclosure, for a channel or signal transmitted periodically, the data to be transmitted (e.g., I/Q data) transmitted in each period may be the same, so the fourth extension field is used for indicating the O-RU to cache the data to be transmitted that corresponds to the section (for example, the indication value of the fourth extension field is 1).

In some embodiments of the disclosure, if the second extension field is used for indicating the activation of caching the first control information, the indication value of the third extension field is not 0, and the extension fields in the first information section extension further comprise a sixth extension field, wherein the sixth extension field is used for indicating the time-domain starting position of each repeated transmission of the signal or channel.

In the embodiment of the disclosure, the indication value of the third extension field for indicating the remaining number of transmissions of the signal or channel is not 0 (e.g., 10), it indicates that the signal or channel is transmitted repeatedly, the second extension field is used for indicating the activation of caching the first control information (for example, the indication value of the second extension field is 1), and the extension fields in the first information section extension further comprise an extension field for indicating the time-domain starting position of each repeated transmission of the signal or channel.

Optionally, in the embodiment of the disclosure, for a channel or signal transmitted repeatedly, the data to be transmitted (e.g., I/Q data) during each repeated transmission is generally different, so the fourth extension field is used for indicating the O-RU to not cache the data to be transmitted that corresponds to the section (for example, the indication value of the fourth extension field is 0).

In some embodiments of the disclosure, the method further comprises:
clearing the cached first control information after the remaining number of transmissions indicated by the third extension field is transmitted based on the cached first control information.

Exemplarily, if the signal or channel is repeatedly transmitted for 10 times, the control information corresponding to the section indicated by the first extension field is cleared so as to release the ID occupied by the section for use in the transmission of other signals or channels.

In some embodiments of the disclosure, the method further comprises:
if the data to be transmitted in the user plane message transmitted by the O-DU has been cached, clearing the cached data to be transmitted after the remaining number of transmissions indicated by the third extension field is transmitted based on the cached first control information.

In some embodiments of the disclosure, if the section indicated by the first extension field has cached third control information, the method further comprises:
clearing the cached third control information; and
caching the first control information according to the section indicated by the first extension field.

In the embodiment of the disclosure, since each repetitionID is unique, if the O-RU determines, according to the first extension field in the first information section extension carried in the control plane message, that the repetitionID #1 corresponding to the section indicated by the first extension field has been occupied (that is, the repetitionID #1 has cached control information 1), the control information 1 is first cleared, and control information 2 corresponding to the repetitionID #1 is then cached.

Optionally, in the embodiment of the disclosure, the current cached control information can be deactivated by reusing the repetitionID, so that the signaling overhead can be reduced.

In some embodiments of the disclosure, the method further comprises performing at least one of the following operations:
transmitting a first feedback message for caching the first control information to the O-DU; and
transmitting a second feedback message for caching the data to be transmitted that corresponds to the first control information to the O-DU.

In the embodiment of the disclosure, the O-RU may transmit, to the O-DU, a feedback message indicating whether the message is received successfully, so that the O-DU determines the subsequent operation.

Optionally, the O-RU may transmit the first feedback message (e.g., message type 8) to the O-DU, and carries, in the message, an extension field (e.g., the existing extension field “extension 22”) for indicating whether the control plane message is received successfully (or, for indicating whether the first control information is cached successfully).

If it is also necessary to give a feedback for the user plane message, an alarm index may be added in an error management module. For example, if the O-RU fails to obtain the corresponding I/Q data according to the first control information, the alarm index may be reported to the O-DU through the error management module of the management plane.

In some embodiments of the disclosure, the method further comprises:
reporting capability information to the O-DU, the capability information indicating whether the O-RU supports the periodic transmission or repeated transmission of the signal.

In the embodiment of the disclosure, the O-RU may report the capability information to the O-DU. For example, the support for the periodic/repeated transmission capability can be realized by adding a section extension for indicating the periodic/repeated transmission in a section extension list (supported-section-extensions) of the management plane. Specifically, if the supported-section-extensions supported by the O-RU include a section extension for indicating the periodic/repeated transmission, it indicates that the O-RU supports the periodic/repeated transmission. If the supported-section-extensions reported by the O-RU do not include this section extension, it is considered that the O-RU does not support the periodic/repeated transmission.

The capability information is reported to the O-DU, and the capability information may indicate the O-RU's capability to cache messages. Optionally, the capability to cache messages may include information for indicating memory size reserved for caching by the O-RU.

In the embodiment of the disclosure, the O-RU may report, to the O-DU, the memory size for storing the cached control plane message and the memory size for storing the user plane message. If the O-RU reports the capability, the O-DU subsequently needs to consider whether the O-RU has enough space for caching messages when determining whether to cache messages.

Optionally, in the embodiment of the disclosure, the capability to cache messages may be indicated through 1 bit or 2 bits. For example, it is indicated through 1 bit or 2 bits whether the O-RU has the capability to support the caching of the control plane message and/or the user plane message, or the memory size reserved for caching by the O-RU is indicated through 1 bit or 2 bits.

Optionally, in the embodiment of the disclosure, the memory size for storing the cached control plane message and the memory size for storing the user plane message reported to the O-DU by the O-RU may include: the number of cached control plane message and user plane message that can be provided by the O-RU.

In some embodiments of the disclosure, if the first extension field is used for indicating deactivation of caching the first control information, the method further comprises:
clearing the cached first control information according to the extension fields in the first information section extension.

In some embodiments of the disclosure, the method further comprises:
if the data to be transmitted that corresponds to the first control information has been cached, clearing the cached data to be transmitted.

In some embodiments of the disclosure, the extension fields in the first information section extension may further comprise:
a seventh extension field for indicating the number of sections to be stopped.

In the embodiment of the disclosure, the second extension field in the first information section extension is used for indicating the deactivation of caching the first control information (for example, the indication value of the second extension field is 0), the extension fields in the first information section extension is also used for indicating the number of sections to be stopped.

In some embodiments of the disclosure, if an indication value of the seventh extension field is 0 for indicating that all sections in the O-RU stop to be transmitted, the first control information is all the cached control information; and
if the indication value of the seventh extension field is not 0, the first control information is control information corresponding to the section indicated by the first extension field in the cached control information, wherein the number of the first extension field is the same as the indication value of the seventh extension field.

In the embodiment of the disclosure, in order to reduce the overhead for the ID, the indication value of the extension field for indicating the number of sections to be stopped may be set as 0, so as to instruct the O-RU to clear all the cached control information or instruct the O-RU to clear all the cached control information and corresponding data to be transmitted. The control information to be cleared or the control information and corresponding data to be transmitted may also be determined according to the extension field for indicating the number (e.g., 20) of sections to be stopped and the extension field for indicating the section corresponding to the first control information (the number of this extension field (which may correspond to the first extension field above) is 20).

In other embodiments of the disclosure, the first control information further comprises: cached control plane information feedback indication information for indicating whether to feed back a recovery state of the cached control plane information.

In some embodiments of the disclosure, if the O-RU receives the cached control plane information feedback indication information, the O-RU also needs to feed back an indication of the recovery success/failure of each cached control plane message.

Specifically, the recovery state of each cached control plane message may be indicated as SUCCESSFUL/FAILED through a bit map.

In other implementations of the disclosure, the method further comprises:
receiving a control plane message transmitted by the O-RAN distributed unit (O-DU), wherein the control plane message may further comprise the second control information.

Optionally, the second control information comprises second indication information for indicating whether to update the reception time window.

In other implementations of the disclosure, the updating a reception time window of a control plane message or a user plane message based on second control information comprises:
updating the reception time window of the message according to the second indication information for indicating whether to update the reception time window, the message comprising the control plane message or the user plane message.

In other implementations of the disclosure, the second indication information comprises a second information section extension, and the second information section extension comprises at least one of the following extension fields:
an eighth extension field for indicating the control plane message reception time window offset;
a ninth extension field for indicating the control plane message reception time window length;
a tenth extension field for indicating the user plane message reception time window offset; and
an eleventh extension field for indicating the user plane message reception time window length.

In other implementations of the disclosure, the eighth extension field is used for indicating an ending time of the uplink or downlink control plane message reception time window.

Optionally, if an indication value of the eighth extension field is 0, the ending time of the control plane message reception time window is not updated.

Optionally, if the indication value of the eighth extension field is not 0, the ending time of the control plane message reception time window is updated as the configured control plane message reception time window offset.

In other implementations of the disclosure, the eighth extension field is used for indicating an offset of the ending time of the uplink or downlink control plane message reception time window.

Optionally, if the indication value of the eighth extension field is 0, the ending time of the control plane message reception time window is not updated.

Optionally, if the indication value of the eighth extension field is not 0, the ending time of the control plane message reception time window is updated as an ending time of the configured control plane message reception time window plus the offset indicated by the eighth extension field.

In other implementations of the disclosure, the ninth extension field is used for indicating a length of the reception time window corresponding to the updated uplink or downlink control plane message.

Optionally, if an indication value of the ninth extension field is 0, a size of the control plane message reception time window is not updated.

Optionally, if the indication value of the ninth extension field is not 0, the size of the control plane message reception time window is updated as the length of the control plane message reception time window indicated by the ninth extension field.

In other implementations of the disclosure, the ninth extension field is used for indicating an offset value of a length of the updated control plane message reception time window relative to a length of the configured control plane message reception time window.

Optionally, if the indication value of the ninth extension field is 0, the length of the control plane message reception time window is not updated.

Optionally, if the indication value of the ninth extension field is not 0, the length of the control plane message reception time window is updated as the configured control plane message reception time window plus the offset value indicated by the ninth extension field.

In other implementations of the disclosure, the tenth extension field is used for indicating an ending time of the updated downlink user plane message reception time window.

Optionally, if an indication value of the tenth extension field is 0, the ending time of the user plane message reception time window is not updated.

Optionally, if the indication value of the tenth extension field is not 0, the ending time of the user plane message reception time window is updated as an ending time of the configured user plane message reception time window.

In other implementations of the disclosure, the tenth extension field is used for indicating an offset value of the ending time of the updated user plane message reception time window relative to the ending time of the configured user plane message reception time window.

Optionally, if the indication value of the tenth extension field is 0, the ending time of the user plane message reception time window is not updated.

Optionally, if the indication value of the tenth extension field is not 0, the ending time of the user plane message reception time window is updated as the ending time of the configured user plane message reception time window plus the offset indicated by the tenth extension field.

In other implementations of the disclosure, the eleventh extension field is used for indicating a length of the updated downlink user plane message reception time window.

Optionally, if an indication value of the eleventh extension field is 0, the length of the user plane message reception time window is not updated.

Optionally, if the indication value of the eleventh extension field is not 0, a size of the user plane message reception time window is updated as the user plane message reception time window length indicated by the eleventh extension field.

In other implementations of the disclosure, the eleventh extension field is used for indicating an offset value of the length of the updated user plane message reception time window relative to a length of the configured downlink user plane message reception time window.

Optionally, if the indication value of the eleventh extension field is 0, the length of the user plane message reception time window is not updated.

Optionally, if the indication value of the eleventh extension field is not 0, the length of the user plane message reception time window is updated as the configured user plane message reception time window plus the offset value indicated by the eleventh extension field.

In other implementations of the disclosure, the method further comprises:
reporting capability information to the O-DU, the capability information being used for indicating at least one of the following capabilities of the O-RU:
a capability to support the periodic or repeated transmission of the signal or not;
a capability to cache messages; and
a capability to update the reception time window.

In other implementations of the disclosure, the capability to cache messages is used for indicating the capability to cache the user plane and/or control plane messages that can be provided by the O-DU.

In other implementations of the disclosure, the capability to cache messages includes the information for indicating the memory size for caching the message that can be provided by the O-DU.

In other implementations of the disclosure, the capability to cache messages further comprises information for indicating the number of cached messages that can be provided by the O-DU. The message includes the control plane message and/or the user plane message.

In other implementations of the disclosure, the capability to cache messages indicates, through 1 bit or 2 bits, whether the O-RU has the capability to support the caching of the control plane message and/or the user plane message.

In other implementations of the disclosure, the capability to update the reception time window is used for indicating the capability to update the reception time window that can be provided.

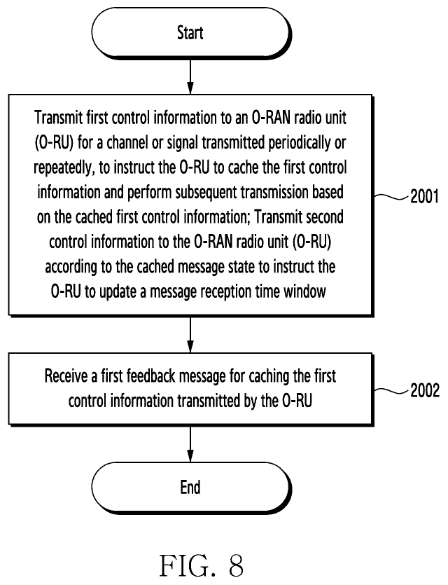

FIG. 8 is a flowchart of a communication method for an O-RAN according to an embodiment of the disclosure.

Referring to FIG. 8, a communication method for an open radio access network (O-RAN) according to an embodiment of the disclosure is shown. The method is applied to an O-RAN distributed unit (O-DU), and the method comprises the following operations.

In operation 2001, first control information is transmitted to an O-RAN radio unit (O-RU) for a channel or signal transmitted periodically or repeatedly, to instruct the O-RU to cache the first control information and perform subsequent transmission based on the cached first control information; and, second control information is transmitted to the O-RU according to the cached message state, to instruct the O-RU to update a message reception time window.

In operation 2002, a first feedback message for caching the first control information transmitted by the O-RU is received.

In some embodiments of the disclosure, if the received first feedback message is acknowledgement information, for data to be transmitted that corresponds to the first control information, the corresponding control information is not transmitted to the O-RU again.

In some embodiments of the disclosure, the first control information comprises transmission resource related information and first indication information for indicating whether to cache the first control information.

In some embodiments of the disclosure, the first indication information of the first control information comprises a first information section extension, and the first information section extension comprises at least one of the following extension fields:
a first extension field for indicating a section corresponding to the first control information;
a second extension field for indicating activation or deactivation of caching the first control information; and
a third extension field for indicating the remaining number of transmissions of the signal or channel.

In some embodiments of the disclosure, the first information section extension further comprises:
a fourth extension field for indicating whether the O-RU caches data to be transmitted that corresponds to the section.

In some embodiments of the disclosure, if the second extension field is used for indicating the activation of caching the first control information, an indication value of the third extension field is 0, and the extension fields in the first information section extension further comprise a fifth extension field for indicating a transmission period of the signal or channel.

In some embodiments of the disclosure, if the second extension field is used for indicating the activation of caching the first control information, the indication value of the third extension field is not 0, and the extension fields in the first information section extension further comprise a sixth extension field for indicating a time-domain starting position of each repeated transmission of the signal or channel.

In some embodiments of the disclosure, the method further comprises:
receiving a second feedback message for caching the data to be transmitted that corresponds to the first control information transmitted by the O-RU.

In some embodiments of the disclosure, the method further comprises:
if at least one of the following is satisfied, for the data to be transmitted that corresponds to the first control information, continuously transmitting the corresponding control information to the O-RU from a next period or next transmission:
the received first feedback message is non-acknowledgement information;
the first feedback message is not received in a predetermined period of [00363] time; and
the received second feedback message is non-acknowledgement information.

In the embodiment of the disclosure, when the O-DU determines according to the feedback message transmitted by the O-RU that the reception of the control plane message and/or the user plane message in the current period or current transmission is failed (or, the caching of the control information and/or the data to be transmitted that corresponds to the control information is failed), the corresponding control information is continuously transmitted to the O-RU from the next period or next transmission.

In some embodiments of the disclosure, the extension fields in the first information section extension further comprise:
a seventh extension field for indicating the number of sections to be stopped.

In some embodiments of the disclosure, if an indication value of the seventh extension field is 0 for indicating that all sections in the O-RU stop to be transmitted, the first control information is all the cached control information; and
if the indication value of the seventh extension field is not 0, the first control information is control information corresponding to the section indicated by the first extension field in the cached control information, wherein the number of the first extension field is the same as the indication value of the seventh extension field.

In the above embodiment of the disclosure, subsequent transmission is performed by the O-RU based on the cached control information, thus avoiding the repeated transmission of the control information, effectively reducing the message load on a fronthaul interface and improving the resource utilization.

According to an indication of the cached control plane information recovery acknowledgement capability of the O-RU, the O-DU can configure the cached control plane information recovery feedback indication to request the O-RU to feed back the recovery success/failure state of each piece of the cached control plane information at the corresponding moment. Thus, the O-DU determines whether to retransmit the control plane information subsequently.

In some embodiments of the disclosure, the O-DU may indicate whether to perform the cached control plane information recovery feedback indication through the existing O-RAN extension field SE22, or may statically configure this function through a management plane.

According to the states of the control plane message and the user plane message cached by the O-RU, the second control information is transmitted to the O-RU, to instruct the O-RU to perform time window adjustment based on the second control information and use a new time window to receive messages.

In some implementations of the disclosure, the second control information comprises second indication information for indicating whether to update the reception time window.

In other implementations of the disclosure, the second indication information of the second control information comprises a second information section extension, and the second information section extension comprises at least one of the following extension fields:
an eighth extension field for indicating the control plane message reception time window offset;
a ninth extension field for indicating the control plane message reception time window length;
a tenth extension field for indicating the user plane message reception time window offset; and
an eleventh extension field for indicating the user plane message reception time window length.

In other implementations of the disclosure, the eighth extension field is used for indicating an ending time of the reception time window corresponding to the updated uplink and/or downlink control plane message.

In other implementations of the disclosure, the eighth extension field is used for indicating an offset of the ending time of the reception time window corresponding to the uplink or downlink control plane message relative to an ending time of the reception time window corresponding to the configured uplink or downlink control plane message.

In other implementations of the disclosure, the ninth extension field is used for indicating a length of the reception time window corresponding to the updated uplink or downlink control plane message.

In other implementations of the disclosure, the ninth extension field is used for indicating an offset value of the length of the updated uplink or downlink control plane message reception time window relative to a length of the configured control plane message reception time window.

In other implementations of the disclosure, the tenth extension field is used for indicating an ending time of the reception time window corresponding to the updated downlink user plane message.

In other implementations of the disclosure, the tenth extension field is used for indicating an offset value of an ending time of the downlink user plane message reception time window relative to an ending time of the configured user plane message reception time window.

In other implementations of the disclosure, the eleventh extension field is used for indicating a length of the updated downlink user plane message reception time window.

In other implementations of the disclosure, the eleventh extension field is used for indicating an offset value of the length of the updated downlink user plane message reception time window relative to a length of the configured downlink user plane message reception time window.

In some embodiments of the disclosure, the method further comprises:
receiving capability information reported by the O-RU, the capability information being used for indicating at least one of the following capabilities of the O-RU:
a capability to support the periodic or repeated transmission of the signal or not;
a capability to cache messages; and
a capability to update the reception time window.

Depending on the signaling (signal) type and application scenario, the embodiments of the disclosure can be classified as follows:

For activation, it is classified into class A for activation of periodic signals and class B for activation of repeatedly transmitted signals. For deactivation, it is classified as class C for deactivation directly using the extension field, class D for deactivation of the current configuration by reusing repetitionID, and class E for updating the reception time window. The disclosure will be described by the following several embodiments:
Embodiment 1: Activation method for reducing the fronthaul of periodic signals;
Embodiment 2: Activation method for reducing the fronthaul of repeated transmission;
Embodiment 3: Deactivation of periodic/repeated transmission by using a newly added extension field;
Embodiment 4: Deactivation of periodic/repeated transmission by using repetitionID;
Embodiment 5: Method of indicating a recovery state of the cached control plane information; and
Embodiment 6: Method of informing the O-RU to update the reception time window according to the cache condition.

It is to be noted that, the scheme of the disclosure is not limited to the above several embodiments of the disclosure, and any embodiment that uses the related innovations of the disclosure or combines the innovations of the disclosure shall fall into the scope of protection of the disclosure.

### Embodiment 1

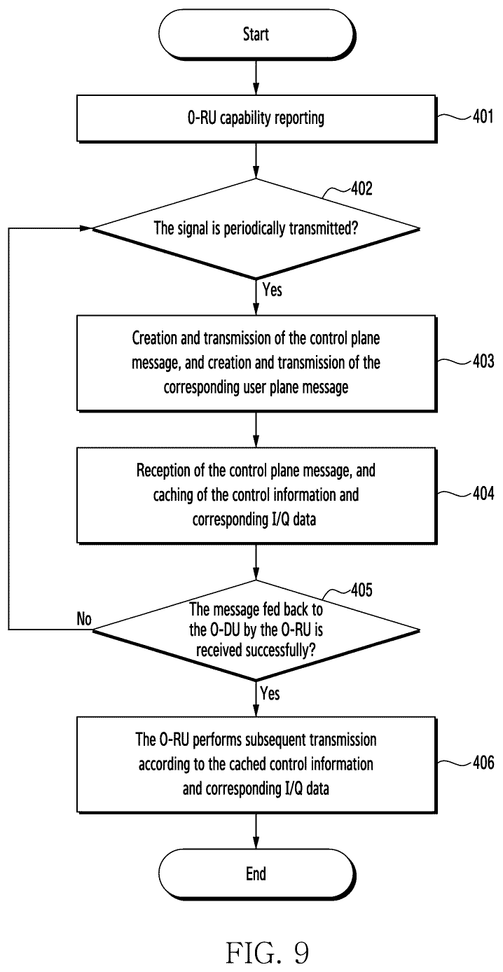

The activation method for reducing the fronthaul of periodic signals will be described with reference to FIG. 9.

FIG. 9 is a first flowchart of a communication method for an O-RAN according to an embodiment of the disclosure.

Referring to FIG. 9, the method comprises the following operations.

Operation 401 is a process of reporting, by the O-RU, the periodic/repeated transmission capability, the capability to cache messages, and the capability to update the reception time window to the O-DU.

The process is performed in the management planes of the O-RU and the O-DU. A section extension related to the periodic/repeated transmission capability is added in the section extension list in the management plane to realize the support for the periodic/repeated transmission capability; and, a section extension related to the capability to update the reception time window is added to realize the support for the capability to update the reception time window. The reporting of the capability to cache messages is added in the management plane.

Optionally, the O-RU reports the supported section extensions to the O-DU through a section extension list (supported-section-extensions). If the supported-section-extensions supported by the O-RU include a section extension related to the periodic/repeated transmission capability, it indicates that the O-RU supports this section extension. Further, when the O-RU supports this section extension, it can be determined that the O-RU supports the periodic/repeated transmission. If the supported-section-extensions supported by the O-RU do not include a section extension related to the periodic/repeated transmission capability, it indicates that the O-RU does not support this section extension. Further, it is determined that the O-RU does not support the periodic/repeated transmission.

Optionally, the O-RU reports, to the O-DU, memory size allocated for caching the control plane message and the user plane message.

Optionally, the O-RU reports the supported section extensions to the O-DU through a section extension list (supported-section-extensions). If the supported-section-extensions supported by the O-RU include a section extension related to the capability to update the reception time window, it indicates that the O-RU supports this section extension. Further, when the O-RU supports this section extension, it can be determined that the O-RU supports the updating of the message reception time window. If the supported-section-extensions supported by the O-RU do not include a section extension related to the updating of the message reception time window, it indicates that the O-RU does not support this section extension. Further, it is determined that the O-RU does not support the updating of the message reception time window.

If the O-DU supports the periodic/repeated transmission, when the O-DU receives the section extension list reported by the O-RU and if the section extension list reported by the O-RU carries the section extension related to the periodic/repeated transmission capability, the periodic/repeated transmission is enabled; otherwise, the periodic/repeated transmission is disabled. If the O-DU does not support the periodic/repeated transmission, for backward compatibility, the O-DU will ignore the periodic/repeated transmission capability of the O-RU. Optionally, the O-DU may continuously monitor the capacity of the fronthaul interface, and updates the capability to cache the control plane/user plane according to whether the capacity of the fronthaul interface is limited. If the capacity of the fronthaul interface is not limited, it can be instructed to stop caching the control plane/user plane.

Operation 402 is a process of triggering the periodic/repeated transmission function.

The process is performed in the O-DU, and the O-DU determines when to perform the periodic/repeated transmission. The embodiment is mainly specific to periodic signals, such as CSI-RSs and SSBs, but it is not limited thereto.

Specifically, the O-DU will determine, according to one or more of the configuration information (e.g., period and offset, semi-static) of the transmitted signal, the periodic scheduling information, the signal type and the downlink control information (DCI) of periodic scheduling, whether the signal exhibits the periodic or repetitive characteristic. It should be understood that, in the embodiments of the disclosure, the way of determining, by the O-DU, whether the signal exhibits the periodic or repetitive characteristic is not limited thereto, and the determination can also be performed based on other parameters or characteristics of the signal, which will not be limited in the embodiments of the disclosure.

When the signal is transmitted periodically or repeatedly and the resource position occupied by the transmission in each period is fixed, for the control information, other information except for the time-domain starting position in each transmission is the same; or, if the O-RU feedback failure is processed for the current periodic transmission, the periodic/repeated transmission is performed when the next periodic transmission is triggered. When the signal is determined as a periodic signal, it is determined according to the ACK feedback of the O-RU whether the signal has cached the corresponding control information and I/Q data in the O-RU; if the corresponding control information and I/Q data have been cached, an operation 406 will be performed; and, if the corresponding control information and I/Q data have not been cached, an operation 403 will be performed at a next periodic transmission moment.

In the embodiment of the disclosure, the O-RU feedback failure is determined in the following way:
1. When only the control plane message needs to be fed back, if the control plane feedback message is not received over time, or if the received feedback is a NACK message, the O-RU feedback failure is determined.
2. When both the control plane message and the user plane message need to be fed back, if only the feedback of the control plane is failed, or only the feedback of the user plane is failed, or the feedbacks of the control plane and the user plane are failed, the O-RU feedback failure is determined.

The above only shows a simplified method of determining the O-RU feedback failure, but the implementation is not limited to this method. For example, if both the control plane message and the user plane message are fed back, but the control plane feedback is successful and the user plane feedback is failed, when the next periodic transmission is triggered, the repeated transmission and feedback of only the user plane message can be considered.

The method of determining the O-RU feedback failure is also applied to the following Embodiment 2, Embodiment 3 and Embodiment 4, and will not be repeated hereinafter.

Operation 403 is the creation and transmission of the control plane message and the user plane message corresponding to the periodic signal. The process is performed in the O-DU. The creation and transmission process of the control plane message is the same as the creation and transmission process of the existing related control plane message, and a newly added section extension structure can be defined as in Table 1 below:

TABLE 1

| | | | | | | | | #of | |
|---|---|---|---|---|---|---|---|---|---|
| 0 (msb) | 1 | 2 | 3 | 4 | 5 | 6 | 7 (lsb) | bytes | |
| ef | extType | | | | | | | 1 | Octet |
| | | | | | | | | | N |
| extLen | | | | | | | | 1 | N + 1 |
| repetitionId | repetitionNum = 0 | | | | | dataBuffer | reserved | 1 | N + 2 |
| AddRel = 1 | | | | | | | | | |

| | | |
|---|---|---|
| repetitionId [7:0] | 1 | N + 3 |
| Time Interval T | 1 | N + 4 |
| Zero padding | 1 | N + 7 |

Each extension field in the extension structure shown in the above Table 1 is described below.

extension flag (ef): it is an extension identifier which occupies 1 bit. When ef=1, it indicates that there are other section extensions after the section extension; and,

when ef=0, it indicates that this extension is the last section extension. It should be understood that, if the section extension exists, the ef in the previous section description or section extension is identified as 1.

extension type (extType): it occupies 7 bits, indicating the extension type. For the extension type, it may be filled with a number of the section extension. For example, from the number 0, if there are other section extensions (e.g., extension type 0, extension type 1 and extension type 2) before the section extension, the extension type of the section extension is numbered as 3.

extension length (extLen): it occupies 8 bits, and it is a size of the extension structure, indicating how many 32-bit or 4-byte the whole extension occupies.

repetitionIdAddRel: it occupies 1 bit, indicating the activation or deactivation of the periodic/repeated transmission. For example, when repetitionIdAddRel is 1, activation is indicated; and, when repetitionIdAddRel is 0, deactivation is indicated.

repetitionNum: it occupies 1 bit, indicating the remaining number of transmissions. For example, when repetitionNum is 0, the periodic transmission is indicated. At this time, the number of transmissions is infinite.

dataBuffer: it occupies 1 bit, indicating whether the I/Q data corresponding to the section is cached. For example, when dataBuffer is 1, it indicates that the I/Q data needs to be cached; and, when dataBuffer is 0, it indicates that the I/Q data is not cached.

repetitionID: it occupies 8 bits, and each ID uniquely corresponds to (is bound with) one sectionID.

Time interval T: it occupies 8 bits, indicating the period interval for caching messages.

zero pad to 4-byte boundary: zero padding is performed, so that the number of bytes occupied by the section extension is consistent with the number of bytes defined by extLen.

It is to be noted that the bit length setting of the above fields is only an example. If the number of bits occupied by some fields is increased or decreased, or indicated by different indication methods, it is also applied to this patent (for example, the number of bits of the repetitionID is extended from 8 bits to 16 bits, and the period is only indicated by the number of symbols or slots, or the like).

It is also to be noted that, the extension field repetitionID may correspond to the above first extension field, the extension field dataBuffer may correspond to the above fourth extension field, the extension field repetitionIdAddRel may correspond to the above second extension field, the extension field repetitionNum may correspond to the above third extension field, and the extension field Time interval T may correspond to the above fifth extension field. Optionally, Time interval T may be at least one of frameNum, subframeNum, slotNum and SymbolNum. For example, if frameNum=1 and other extension fields are 0, it indicates that the period is 1 frame, or if frameNum=1, subframeNum=1 and other extension fields are 0, it indicates that the period is 1 frame+1 subframe.

For the activation of the periodic signal, each section corresponding to the periodic signal is associated with the periodic/repeated transmission extension, the extension field repetitionIdAddRel is fixed as 1, repetitionNum is fixed as 0, and the period is the transmission period corresponding to this signal. If the I/Q data corresponding to the section during each transmission is the same, the I/Q data can be cached to the O-RU. Thus, the corresponding extension field dataBuffer is 1.

For the failure of the simplified feedback of the O-RU, the creation and transmission of both the user plane message and the control plane message need to be considered. However, in a scenario where the O-RU feeds back the control plane successfully but feeds back the user plane unsuccessfully, it is also possible to only consider the transmission of the user plane message. Processing both the user plane message and the control plane message or only the user plane message depends on the method of determining the O-RU feedback failure in the operation 402. The processing is also applied to Embodiment 2, Embodiment 3 and Embodiment 5, and will not be repeated hereinafter.

Operation 404 is a process of receiving the control plane message and the user plane message corresponding to the periodic signal transmission. The process is performed in the O-RU.

The O-RU parses the received messages. For the control plane message, it is identified according to the extension field extType whether it includes the periodic/repeated transmission extension, and if it includes the periodic/repeated transmission extension, the corresponding control information (which may correspond to the above first control information) is saved. If the extension field dataBuffer in the section extension structure indicates that the I/Q data needs to be cached, the I/Q data of the section corresponding to the control information needs to be extracted from the user plane message and then cached.

Operation 405 is an ACK process. The process is performed in the O-RU.

After the O-RU caches the control information and the I/Q data, the processing result needs to be informed to the O-DU. The result feedback of the O-RU is classified into a control plane message feedback and a user plane message feedback.

The control plane message feedback may be realized by means of the existing section extension 22 and message type 8. When the section is associated with the periodic/repeated transmission extension, it is also associated with one extension 22. When the O-RU receives the section in the control plane message and performs processing successfully, by carrying ack/NackReqID in the extension 222 through the message type 8, the O-DU is notified whether the control plane message is received successfully.

Specifically, if the extension supports a recovery success/failure acknowledgement of the cached control plane information, the O-RU also needs extensions for support, specifically referring to the description of Embodiment 5.

The user plane message feedback may be realized by adding a corresponding alarm index in the error management. Specifically, when it is found that it is necessary to cache the I/Q data of the section corresponding to the control information by parsing the control plane message, if the O-RU successfully obtains the I/Q data corresponding to the section, it indicates that the user plane data is received successfully, and the error management module does not perform processing. If the I/Q data corresponding to the section is obtained unsuccessfully, it indicates that the user plane data is cached unsuccessfully. At this time, a newly added alarm index (flag) is reported to the O-DU through the error management module of the management plane.

Operation 406 is a processing process of the periodic/repeated transmission. The process is performed in the O-RU.

If the O-RU has cached the control information and the corresponding I/Q data (it may be determined by the operation 402 that the control information and the corresponding I/Q data has been cached, or the control information and the corresponding I/Q data is cached by the operation 404), the transmission starting position of the next piece of control information of the signal may be determined according to the cached control information. Optionally, the transmission starting position of the next piece of control information may be inferred by using the Time interval T. Meantime, the O-DU will not repeatedly transmit the cached control plane message and transmit or receive the corresponding user plane message.

Specifically, the transmission starting position of the next piece of control information is the starting transmission moment (i.e., time-domain starting position) of the cached control information (which may be interpreted as the current control information) plus the period. Except for the time-domain starting position, the next piece of control information is consistent with the cached control information. For the next piece of control information, if the O-RU does not cache the corresponding I/O data, the O-RU needs to receive the corresponding user plane message, and the processing process after reception is consistent with the existing process. If the corresponding I/Q data has been cached, the I/Q data corresponding to the section is directly read from the cache, and the process after obtaining the I/Q data is consistent with the existing process.

### Embodiment 2

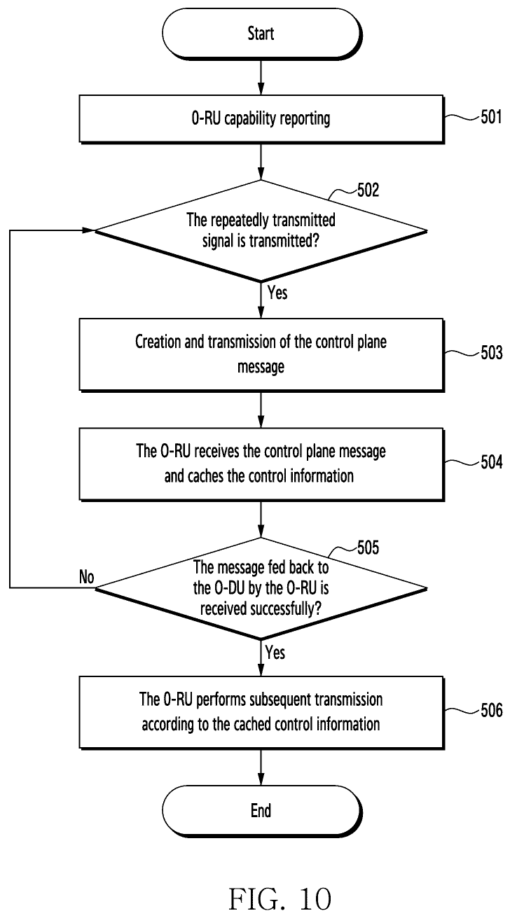

The activation method for reducing the fronthaul of repeated transmission will be described with reference to FIG. 10.

FIG. 10 is a second flowchart of a communication method for an O-RAN according to an embodiment of the disclosure.

Referring to FIG. 10, the method comprises the following operations.

Operation 501 is a process of reporting, by the O-RU, the periodic/repeated transmission capability to the O-DU. A specific implementation of the process may refer to the content of the operation 401 in the above Embodiment 1 and will be repeated here.

Operation 502 is a process of triggering the periodic/repeated transmission function.

The process is performed in the O-DU, and the O-DU determines when to perform the periodic/repeated transmission. This embodiment is mainly specific to repeatedly transmitted signals, such as uplink repeated transmission, but it is not limited thereto.

Specifically, when the repeated transmission occurs, the number of subsequent transmissions may be known in advance, and other control information except for the time-domain transmission starting moment is the same in each retransmission. For example, for the control information, except for the time-domain starting moment, other information may be reused. When the repeated transmission is determined, it is determined according to the ACK feedback of the O-RU whether the signal has cached the corresponding control information and I/Q data in the O-RU. If the corresponding control information and I/Q data have been cached, an operation 506 will be performed, and if the corresponding control information and I/Q data have not been cached, the process will proceed to an operation 503.

Operation 503 is the creation and transmission of the control plane message corresponding to the repeatedly transmitted signal. The process is performed in the O-DU. The creation and transmission process of the control plane message is the same as the creation and transmission process of the existing related control plane message, and a newly added section extension structure can be defined as in Table 2 below:

TABLE 2

| | | | | | | | | #of | |
|---|---|---|---|---|---|---|---|---|---|
| 0 (msb) | 1 | 2 | 3 | 4 | 5 | 6 | 7 (lsb) | bytes | |
| ef | extType | | | | | | | 1 | Octet |
| | | | | | | | | | N |
| extLen | | | | | | | | 1 | N + 1 |
| repetitionId | repetitionNum | | | | | dataBuffer | reserved | 1 | N + 2 |
| AddRel = 1 | | | | | | | | | |

| | | |
|---|---|---|
| repetitionId [7:0] | 1 | N + 3 |
| Time interval T2 for the 2nd transmission | 1 | N + 4 |
| Time interval T3 for the 3rd transmission | 1 | N + 5 |
| . . . | 1 | |

Some fields in the extension structure shown in the above Table 2 are the same as the fields in the extension structure shown in Table 1 in Embodiment 1. For the simplicity of description, the same fields will not be repeated here, and only different fields will be described below.

Time interval Tn for nth transmission: it occupies 8 bits, indicating the time interval for the nth repeated transmission. When the periodic or repeated transmission has regular different intervals, the periodic/repeated time interval may be indicated by combining multiple intervals.

It is to be noted that the bit length setting of the above fields is only an example. If the number of bits occupied by some fields is increased or decreased, or indicated by different indication methods, it is also applied to the scheme in the embodiments of the disclosure. For example, the number of bits of the repetitionID is extended from 8 bits to 16 bits, and the period is only indicated by the number of symbols or slots, and the like. However, it is not limited thereto.

For the activation of the repeated transmission, each section corresponding to the transmission is associated with the periodic/repeated transmission extension, the extension field repetitionIdAddRel is fixed as 1, and the extension field repetitionNum is the remaining number of retransmissions. Considering that the I/Q data will not be the same in the current retransmission, the extension field dataBuffer is 0. The time-domain starting moment corresponding to each subsequent retransmission may be successfully filled in the extension fields, and the number of the retransmission time-domain information is consistent with the value of repetitionNum.

Operation 504 is a process of receiving the control plane message corresponding to the transmission of the repeatedly transmitted signal. A specific implementation of the process may refer to the content of the operation 404 in Embodiment 1, but the processing of the user plane message is not involved in the embodiment.

Operation 505 is an ACK process. A specific implementation of the process may refer to the content of the operation 405 in Embodiment 1, but the processing of the user plane message is not involved in the embodiment.

Operation 506 is a processing process of the periodic/repeated transmission. The process is performed in the O-RU.

A specific implementation of the process may be basically consistent with the description of the operation 406 in Embodiment 1. In the embodiment of the disclosure, the starting position of each repeated transmission is known but may not be periodic. The O-DU provides the corresponding transmission interval T for each repeated transmission, and then, the O-RU may determine the transmission starting position of the next piece of control information of the signal according to the cached control information. Specifically, the repeated transmission is performed according to the transmission starting position and the number of transmissions indicated by the extension fields. When the O-RU completes the (repetitionNum)th transmission, the O-RU automatically clears the control information and I/Q data corresponding to the extension field repetitionID.

### Embodiment 3

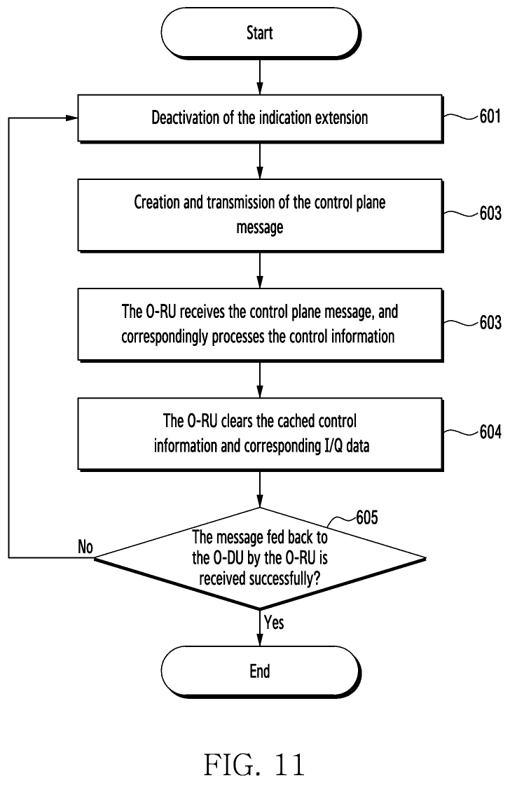

The method of deactivating of the periodic/repeated transmission by using an extension field will be described with reference to FIG. 11.

FIG. 11 is a third flowchart of a communication method for an O-RAN according to an embodiment of the disclosure.

Referring to FIG. 11, the method comprises the following operations.

Operation 601 is a process of transmitting, by the O-DU, a deactivation indication extension to the O-RU for determination.

The process is performed in the O-DU. When the activated periodic/repeated transmission needs to be terminated, the O-DU triggers a deactivation process and issues a deactivation instruction, and then, the O-DU will wait for an ACK feedback corresponding to the control plane message. After an ACK message fed back by the O-RU is received, the deactivation process is terminated. After the O-DU receives a NACK message or waits for the ACK message until timeout, the deactivation process is triggered again.

Operation 602 is the creation and transmission of the control plane message corresponding to the periodic/repeated transmission deactivation indication. The process is performed in the O-DU. The creation and transmission process of the control plane message is the same as the creation and transmission process of the existing related control plane message, and a newly added section extension structure may be defined as in Table 3 below:

TABLE 3

| | | | | | | | | #of | |
|---|---|---|---|---|---|---|---|---|---|
| 0 (msb) | 1 | 2 | 3 | 4 | 5 | 6 | 7 (lsb) | bytes | |
| ef | extType | | | | | | | 1 | Octet N |
| extLen | | | | | | | | 1 | N + 1 |
| repetitionId | repetitionNum [8:2] | | | | | | | 1 | N + 2 |
| AddRel = 0 | | | | | | | | | |

| | | | |
|---|---|---|---|
| repetitionNum [1:0] | reserved | 1 | N + 3 |

| | | |
|---|---|---|
| repetitionId [7:0] (The first released repetition Id) | 1 | N + 4 |
| repetitionId [7:0] (The second released repetition Id) | 1 | N + 5 |
| . . . | | |
| repetitionId [7:0] (The Nth released repetition Id) | 1 | |
| Zero padding to achieve 4-byte alignment as needed | 1 | |

Some fields in the extension structure shown in the above Table 3 are the same as the fields in the extension structure shown in Table 1 in Embodiment 1. For the simplicity of description, the same fields will not be repeated here, and only different fields will be described below.

repetitionIdNum: it occupies 9 bits, indicating the number of repetitionID to be stopped for periodic/repeated transmission. When repetitionIdNum is 0, it indicates that all periodic/repeated transmissions in the O-RU are stopped.

For deactivation, the extension field repetitionIdAddRel is fixed as 0. The value of repetitionIdNum is consistent with the number of repetitionID. If repetitionIdNum is 0, the extension section may not carry any repetitionID.

It is to be noted that the bit length setting of the above fields is only an example. If the number of bits occupied by some fields is increased or decreased, or indicated by different indication methods, it is also applied to the scheme in the embodiments of the disclosure. For example, the number of bits of the repetitionID is extended from 8 bits to 16 bits. However, it is not limited thereto.

It is also to be noted that, the extension field repetitionIdNum may correspond to the above seventh extension field, the extension field repetitionID may correspond to the above first extension field, and the extension field repetitionIdAddRel may correspond to the above second extension field.

When the deactivation is triggered, the O-DU determines the repetitionID to be deactivated and constructs a corresponding section extension structure accordingly, then selects one section in the control plane message that is to be transmitted at this time, and attaches the section extension structure to the section.

Operation 603 is a process of receiving the control plane message corresponding to the periodic/repeated transmission.

A specific implementation of the process may refer to the content of the operation 404 in Embodiment 1, but the processing of the user plane message is not involved in the embodiment.

Operation 604 is a process of the deactivation processing of the periodic/repeated transmission.

The process is performed in the O-RU. When the section extension structure for deactivation is received, the control information and I/Q data corresponding to the repetitionID carried in the section extension structure are found out and cleared. If repetitionIdNum is 0, all the control information and I/Q data cached in the O-RU are cleared.

Operation 605 is an ACK process. A specific implementation of the process may refer to the content of the operation 405 in Embodiment 1, but the processing of the user plane message is not involved in the embodiment.

It is to be noted that there is no strict sequential processing relationship between the operation 604 and the operation 605 in the embodiment.

### Embodiment 4: Method of Deactivating of the Periodic/Repeated Transmission by Using repetitionID

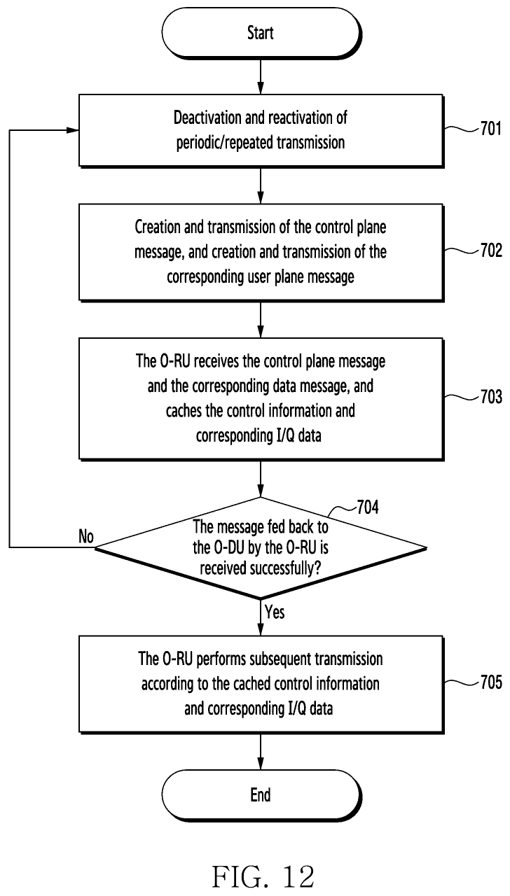

The method of deactivating of the periodic/repeated transmission by using repetitionID will be described with reference to FIG. 12.

FIG. 12 is a fourth flowchart of a communication method for an O-RAN according to an embodiment of the disclosure.

Referring to FIG. 12, the method comprises the following operations.

Operation 701 is a process of transmitting, by the O-DU, a deactivation indication to the O-RU for determination.

The process is performed in the O-DU. When it is necessary to terminate the activated periodic/repeated transmission and other periodic/repeated transmissions need to be activated, the process is triggered. After an ACK message fed back by the O-RU is received, the process ends. If a NACK message is received or the ACK message is not received (it waits for the ACK message until timeout), the process also ends. Then, Embodiment 3 is referenced for the deactivated periodic/repeated transmission, Embodiment 1 is referenced for the newly activated periodic transmission, and Embodiment 2 is referenced for the newly activated repeated transmission.

In the embodiment of the disclosure, to activate the caching of the first control information, if the repetitionID corresponding to the first control information has cached the third control information and corresponding I/Q data, the repetitionID may be directly reused to cache the first control information after the third control information and corresponding I/Q data corresponding to the repetitionID are cleared. At this time, it is unnecessary to use the extension field structure in Embodiment 3 to deactivate the first control information corresponding to the repetitionID. If the reusing of the repetitionID is completed, the O-RU may transmit the ACK message to the O-DU.

If the O-DU receives the NACK message or does not receive the ACK message, it is necessary to perform the process of Embodiment 3 to deactivate the repetitionID and then perform Embodiment 1 or Embodiment 2.

Operation 702 is the creation and transmission of the control plane message and the user plane message corresponding to the periodic/repeated transmission deactivation and activation.

The process is performed in the O-DU. The creation and transmission process of the control plane message is the same as the creation and transmission process of the existing related control plane message. For activation, the section extension structure may refer to Embodiment 1 or Embodiment 2, specifically depending on the signal type.

It is to be noted that, the field repetitionID in the section extension structure in the embodiment must have been cached and used by the O-RU. For example, some or all repetitionID (to be activated) in the section extension structure in the embodiment reuse the deactivated repetitionID. If the number of repetitionID to be deactivated is greater than the number of repetitionID to be activated, the section also needs to add more repetitionID to the corresponding deactivated section extension structure in the way of Embodiment 3.

Operation 703 is a process of receiving the control plane message and the user plane message corresponding to the periodic/repeated transmission. A specific implementation of the process may refer to the content of the Operation 404 in Embodiment 1.

Operation 704 is an ACK process. A specific implementation of the process may refer to the content of the Operation 405 in Embodiment 1.

Operation 705 is a processing process of the periodic/repeated transmission. The process is performed in the O-RU.

A specific implementation of the process may be similar to the operation 406 in Embodiment 1. However, since the repetitionID will be reused in the scheme in the embodiment of the disclosure, before the caching of the control information and I/Q data corresponding to the repetitionID, it is necessary to clear the information already cached by the repetitionID.

For example, to activate the caching of the control information 2, the repetitionID corresponding to the control information 2 is repetitionID #1. If the repetitionID #1 has cached the control information 1 and the I/Q data 1 and if the repetitionID #1 needs to be reused, the control information 1 and the I/Q data 1 may be cleared first, and the control information 2 and the I/Q data 2 corresponding to the repetitionID #1 are then cached.

It is to be noted that the activation/deactivation in the above embodiments are specific to the section. One periodically/repeatedly transmitted signal corresponds to at least one control plane message, one control plane message corresponds to one or more sections, one piece of control information corresponds to one sectionID, and one sectionID corresponds to (is bound with) one repetitionID.

### Embodiment 5: Recovery Success/Failure Indication of the Cached Control Plane Information

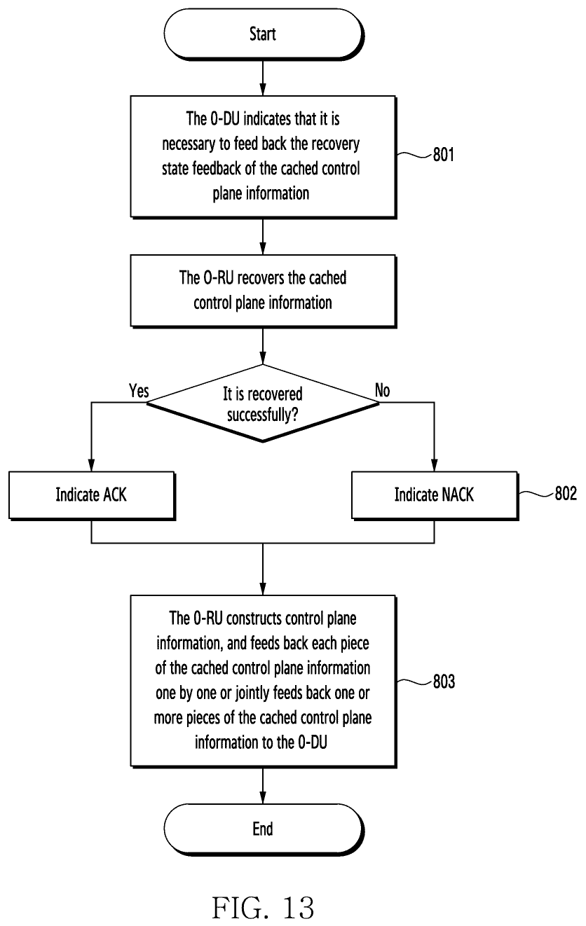

The recovery success/failure indication of the cached control plane information will be described with reference to FIG. 13.

FIG. 13 is a fifth flowchart of a communication method for an O-RAN according to an embodiment of the disclosure.

Referring to FIG. 13, the method comprises the following operations.

In operation 801, the O-DU transmits a request to the O-RU to obtain a recovery state feedback of each cached control plane message. A flag bit bufferedAckNack may be added in the existing section extension 22 of the O-RAN for indication, specifically referring to Table 4 below.

TABLE 4

| | | | | | | | | #of |
|---|---|---|---|---|---|---|---|---|
| 0 (msb) | 1 | 2 | 3 | 4 | 5 | 6 | 7 (lsb) | bytes |

| | | | |
|---|---|---|---|
| ef | extType = 0x16 | 1 | Octet N |

| | | |
|---|---|---|
| extLen = 0x01 (1 word) | 1 | N + 1 |
| ackNackReqId | 2 | N + 2 |
| bufferedAckNack | 1 | N + 4 |
| zero padding to ensure 4-byte boundary | 3 | N + 8 |

Some fields in the extension structure shown in the above Table 4 are the same as the fields in the extension structure shown in Table 1 in Embodiment 1. For the simplicity of description, the same fields will not be repeated here, and only different fields will be described below.

ackNackReqID: it occupies 16 bits, indicating an initial control plane information ID corresponding to the cached control plane allocated by the O-DU. For the control plane information of the information ID and the cached control plane information, the O-RU needs to feed back a cache recovery success/failure state.

bufferedAckNack: it indicates whether to feed back a recovery state of the cached control plane information, where 1 represents YES, and 0 represents NO.

Optionally, the O-DU may also indicate whether the O-RU needs to feed back the recovery state of each cached control plane message by adding a new control plane capability configuration.

In operation 802, the O-RU transmits a cached control plane information recovery success/failure indication to the O-DU.

The process is performed in the O-RU. At the moment when the cached control plane information needs to be recovered, if the O-RU can successfully obtain the cached control plane information, an ACK is indicated; otherwise, a NACK is indicated.

The O-RU indicates the recovery success/failure indication of the cache point corresponding to each piece of control plane information through a bitmap.

In operation 803, the control plane information is created and transmitted.

The process is performed in the O-RU. The creation and transmission process of the control plane message is the same as the creation and transmission process of the existing related control plane message, and a newly added section extension structure may be defined as in Table 5 below:

TABLE 5

| | | | | | | | | #of |
|---|---|---|---|---|---|---|---|---|
| 0 (msb) | 1 | 2 | 3 | 4 | 5 | 6 | 7 (lsb) | bytes |

| | | | |
|---|---|---|---|
| ef | extType | 1 | Octet N |

| | | |
|---|---|---|
| extLen | 1 | N + 1 |
| AckNackReqId | 2 | N + 2 |
| ackNackBitmap | 1 | N + 4 |

Some fields in the extension structure shown in the above Table 5 are the same as the fields in the extension structure shown in Table 1 in Embodiment 1. For the simplicity of description, the same fields will not be repeated here, and only different fields will be described below.

ackNackReqID: it occupies 16 bits, indicating an initial control plane information ID corresponding to the cached control plane allocated by the O-DU. For the control plane information of the information ID and the cached control plane information, the O-RU needs to feed back a cache recovery success/failure state.

ackNackBitmap: it occupies 16 bits, indicating a recovery state of each piece of the cached control plane information. The biggest feature represents a first piece of the cached control plane information, and the second bit represents a second piece of the cached control plane information, and so on. If the numerical value of the second bit is 0, it indicates that the second piece of the cached control plane information is recovered successfully. If the numerical value of the second bit is 1, it indicates that the second piece of the cached control plane information is recovered unsuccessfully.

It is to be noted that the bit length setting of the above fields is only an example. If the number of bits occupied by some fields is increased or decreased, or indicated by different indication methods, it is also applied to the scheme in the embodiments of the disclosure.

Optionally, the O-RU may also directly use the existing section extension 8 in the O-RAN to indicate the recovery success/failure state. A time indication (radio frame number, subframe number, slot number, and symbol ID) may be padded as the time corresponding to the cached control plane information recovery moment.

### Embodiment 6: Informing the O-RU to Update the Reception Time Window According to the Cache Condition

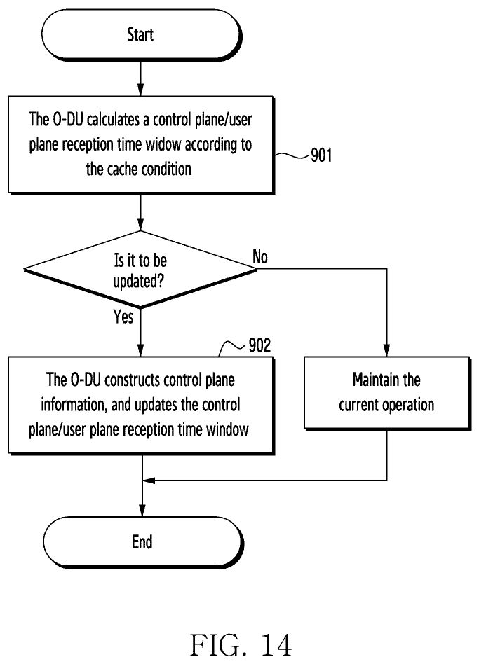

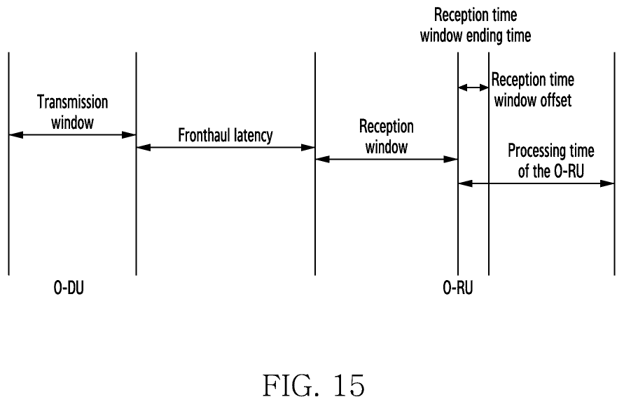

The method of updating the reception time window will be described with reference to FIGS. 14 and 15.

FIG. 14 is a sixth flowchart of a communication method for an O-RAN according to an embodiment of the disclosure.

FIG. 15 is a schematic diagram of adjustment of a time window for an open radio access network (O-RAN) according to an embodiment of the disclosure.

Referring to FIGS. 14 and 15, the method comprises the following operations.

In operation 901, the O-DU transmits reception time window update information of an uplink or downlink control plane message and reception time window update information of a downlink user plane message to the O-RU.

The process is performed in the O-DU. When it is necessary to update the reception time window, the O-DU will indicate the reception time window update information of the uplink or downlink control plane message and the reception time window update information of the downlink user plane information through a control plane message.

Specifically, for the calculation of a time window offset of the user plane message, the calculation may be performed in combination with one or more of the following information: the number of control plane/user plane messages, the number of resource elements (REs) occupied by each user plane message, a user plane message header size, a compressed bit width, the number of multi-user simultaneous scheduling layers, the number of carriers, and the like.

Specifically, for the calculation of a time window offset of the control plane message, the calculation may be performed in combination with one or more of the following information: the number of control plane messages, a size of the control plane message, the number of multi-user simultaneous scheduling layers, the number of carriers, and the like.

In operation 902, the control plane information is created and transmitted.

The process is performed in the O-DU. The creation and transmission process of the control plane message is the same as the creation and transmission process of the existing related control plane message, and a newly added section extension structure may be defined as in Table 6 below:

TABLE 6

| | | | | | | | | #of |
|---|---|---|---|---|---|---|---|---|
| 0 (msb) | 1 | 2 | 3 | 4 | 5 | 6 | 7 (lsb) | bytes |

| | | | |
|---|---|---|---|
| ef | extType | 1 | Octet N |
| | extLen | 1 | N + 1 |
| | C-Plane reception WindowOffset[15:8] | 1 | N + 2 |
| | C-Plane reception WindowOffset[7:0] | 1 | N + 3 |
| Reserved | C-Plane reception WindowSize[13:8] | 1 | N + 4 |
| | C-Plane reception WindowSize[7:0] | 1 | N + 5 |
| | U-Plane reception WindowOffset[15:8] | 1 | N + 6 |
| | U-Plane reception WindowOffset[7:0] | 1 | N + 7 |
| Reserved | U-Plane reception WindowSize[13:8] | 1 | N + 8 |
| | U-Plane reception WindowSize[7:0] | 1 | N + 4 |

Some fields in the extension structure shown in the above Table 6 are the same as the fields in the extension structure shown in Table 1 in Embodiment 1. For the simplicity of description, the same fields will not be repeated here, and only different fields will be described below.

C-Plane reception WindowOffset: it occupies 16 bits, indicating the offset of the ending time of the updated control plane message reception time window. When C-Plane receptionWindowOffset is 0, it indicates that it is unnecessary to update the ending time of the reception time window of the uplink/downlink control plane message.

C-Plane reception WindowSize: it occupies 14 bits, indicating the length of the ending time of the updated control plane message reception time window. When C-Plane receptionWindowSize is 0, it indicates that it is unnecessary to update the reception time window length of the uplink/downlink control plane message. If the value of the reception time window is less than (T2a_max−T2a_min), the O-RU will successfully receive the control plane message.

U-Plane reception WindowOffset: it occupies 16 bits, indicating the offset of the ending time of the updated user plane message reception time window. When U-Plane receptionWindowOffset is 0, it indicates that it is unnecessary to update the ending time of the reception time window of the uplink/downlink user plane message.

U-Plane reception WindowSize: it occupies 14 bits, indicating the length of the user plane message reception time window to be updated. When U-Plane reception WindowSize is 0, it indicates that it is unnecessary to update the length of the reception time window of the uplink/downlink user plane message. If the value of the reception time window is less than (T2a_max−T2a_min), the O-RU will successfully receive the control plane message.

It is to be noted that the bit length setting of the above fields is only an example. If the number of bits occupied by some fields is increased or decreased, or indicated by different indication methods, it is also applied to the scheme in the embodiments of the disclosure.

It is also to be noted that, the extension field C-Plane receptionWindowOffset may correspond to the above eighth extension field, the extension field C-Plane receptionWindowSize may correspond to the above ninth extension field, the extension field U-Plane reception WindowOffset may correspond to the above tenth extension field, and the extension field U-Plane reception WindowSize may correspond to the above eleventh extension field.

Specifically, upon receiving the reception time window adjustment indication transmitted by the O-DU, the O-RU will update the reception time window. The updated reception time window will be continuously valid until new reception time window adjustment information is detected or it is time to end the caching.

Optionally, the method of updating the control plane time window is as follows:

$$T2a\_min \_cp after updating = T2a\_min \_cp \_dl before updating + C - plane receptionWindowOffset .$$

$$T2a\_max \_cp after updating = T2a\_min \_cp \_dl before updating + C - plane receptionWindowOffset + C - plane receptionWindowSize .$$

Optionally, the method of updating the user plane time window is as follows:

$$T2a\_min \_up after updating = T2a\_min \_cp \_dl before updating + U - plane receptionWindowOffset .$$

$$T2a\_max \_up after updating = T2a\_min \_cp \_dl before updating + U - plane receptionWindowOffset + U - plane receptionWindowSize .$$

Based on the same principle as the method provided in the embodiments of the disclosure, an embodiment of the disclosure provides an electronic device, comprising: a transceiver; and a processor coupled to the transceiver, wherein the at least one processor is configured to implement the method provided in any optional embodiment of the disclosure.

Optionally, the electronic device may be an O-RAN distributed unit (O-DU), and the at least one processor may be configured to perform the method performed by the O-DU provided in any one of the embodiments of the disclosure.

Optionally, the electronic device may be an O-RAN radio unit (O-RU), and the at least one processor may be configured to perform the any method performed by the O-RU provided in the embodiments of the disclosure.

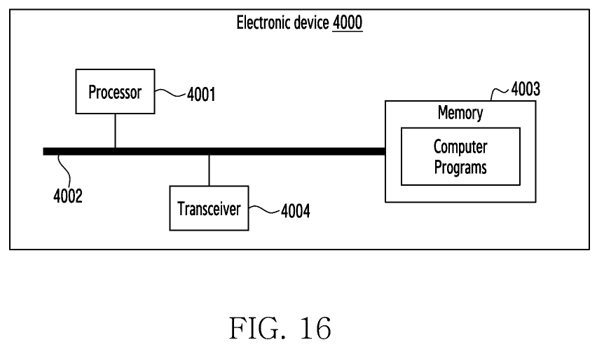

FIG. 16 illustrates a schematic structure diagram of an electronic device according to an embodiment of the disclosure.

Referring to FIG. 16, an electronic device 4000 may include a processor 4001 and memory 4003. The processor 4001 is connected to the memory 4003, for example, through a bus 4002. Optionally, the electronic device 4000 may further include a transceiver 4004 that can be used for data exchange, for example, transmission and reception of data, between the electronic device and other electronic device. It should be noted that, in practical applications, the number of transceiver 4004 is not limited to one, and the structure of the electronic device 4000 does not constitute any limitations to the embodiments of the disclosure. Optionally, the electronic device may be an O-DU, an O-RU or other network nodes.

The processor 4001 may be a central processing unit (CPU), a general-purpose processor, a digital signal processor (DSP), an application specific integrated circuit (ASIC), a field programmable gate array (FPGA), or other programmable logic devices, transistor logic devices, hardware components, or any combination thereof. It may implement or perform various logical blocks, modules and circuits described in connection with the disclosure. The processor 4001 may also be a combination for realizing computing functions, for example, a combination of one or more microprocessors, a combination of a DSP and a microprocessor, and the like.

The bus 4002 may include a path to transfer information between the components described above. The bus 4002 may be a peripheral component interconnect (PCI) bus, or an extended industry standard architecture (EISA) bus, and the like. The bus 4002 may be an address bus, a data bus, a control bus, and the like. For ease of presentation, the bus is represented by only one thick line in FIG. 16. However, it does not mean that there is only one bus or one type of buses.

The memory 4003 may be, but not limited to, read only memories (ROMs) or other types of static storage devices that can store static information and instructions, random access memories (RAMs) or other types of dynamic storage devices that can store information and instructions, may be electrically erasable programmable read only memories (EEPROMs), compact disc read only memories (CD-ROMs) or other optical disk storages, optical disc storages (including compact discs, laser discs, discs, digital versatile discs, blue-ray discs, or the like), magnetic storage media or other magnetic storage devices, or any other media that can carry or store desired program codes in the form of instructions or data structures and that can be accessed by computers.

The memory 4003 is used to store application codes (computer programs) for executing the solutions of the disclosure, and is controlled by the processor 4001. The processor 4001 is used to execute the application codes stored in the memory 4003 to implement the solution provided in any method embodiment described above.

Embodiments of the disclosure provide a computer-readable storage medium having a computer program stored on the computer-readable storage medium, the computer program, when executed by a processor, implements the steps and corresponding contents of the foregoing method embodiments.

Embodiments of the disclosure also provide a computer program product including a computer program, the computer program when executed by a processor can implement the steps and corresponding contents of the preceding method embodiments.

According to embodiments of the disclosure, a method may be performed by an open radio access network (O-RAN) radio unit (O-RU). The method may comprise caching first control information for a signal transmitted periodically or repeatedly. The method may comprise performing subsequent transmission based on the cached first control information.

In an embodiment of the disclosure, the method may comprise receiving a control plane message transmitted by an O-RAN distributed unit (O-DU), the control plane message comprising at least one piece of the first control information.

In an embodiment of the disclosure, the first control information may comprise first indication information for indicating whether to cache the first control information. For example, caching first control information may comprise caching the first control information according to the first indication information for indicating whether to cache the first control information.

In an embodiment of the disclosure, the method may comprise determining whether to cache data to be transmitted that corresponds to the first control information and if it is determined to cache the data to be transmitted, and caching data to be transmitted in a user plane message transmitted by the O-DU. For example, performing subsequent transmission based on the cached first control information may comprise transmitting the cached data to be transmitted based on the cached first control information.

In an embodiment of the disclosure, the first indication information may comprise a first information section extension. For example, the first information section extension may comprise at least one of a first extension field for indicating a section corresponding to the first control information, a second extension field for indicating activation or deactivation of caching the first control information, and a third extension field for indicating the remaining number of transmissions of the signal.

In an embodiment of the disclosure, the first information section extension may comprise a fourth extension field for indicating whether the O-RU caches data to be transmitted that corresponds to the section.

In an embodiment of the disclosure, if the second extension field is used for indicating the activation of caching the first control information, an indication value of the third extension field is 0, and the first information section extension may comprise a fifth extension field for indicating a transmission period of the signal.

In an embodiment of the disclosure, if the second extension field is used for indicating the activation of caching the first control information, an indication value of the third extension field is not 0, and the first information section extension may comprise a sixth extension field for indicating a time-domain starting position of each repeated transmission of the signal.

In an embodiment of the disclosure, the method may comprise clearing the cached first control information after the remaining number of transmissions indicated by the third extension field is transmitted based on the cached first control information.

In an embodiment of the disclosure, if the second extension field is used for indicating the deactivation of caching the first control information, the method may comprise clearing the cached first control information according to the extension fields in the first information section extension.

In an embodiment of the disclosure, the method may comprise if the data to be transmitted that corresponds to the first control information has been cached, clearing the cached data to be transmitted.

In an embodiment of the disclosure, the extension fields in the first information section extension may comprise a seventh extension field for indicating the number of sections to be stopped. If an indication value of the seventh extension field is 0 for indicating that all sections in the O-RU stop to be transmitted, the first control information is all the cached control information. If the indication value of the seventh extension field is not 0, the first control information is control information corresponding to the section indicated by the first extension field in the cached control information, wherein the number of the first extension field is the same as the indication value of the seventh extension field.

In an embodiment of the disclosure, the first control information may comprise cached control plane information feedback indication information for indicating whether to feed back a recovery state of the cached control plane information. The method may comprise if it is determined to feed back the recovery state of each piece of the cached control plane information, indicating the recovery state of each piece of the cached control plane information as SUCCESSFUL through first information, and indicating the recovery state of each piece of the cached control plane information as FAILED through second information.

According to embodiments of the disclosure, an open radio access network (O-RAN) radio unit (O-RU) may comprise a transceiver. The O-RU may comprise at least one processor including processing circuitry. The O-RU may comprise memory, including one or more storage media, storing instructions. The instructions, when executed by the at least one processor individually or collectively, cause the O-RU to cache first control information for a signal transmitted periodically or repeatedly. The instructions, when executed by the at least one processor individually or collectively, cause the O-RU to perform subsequent transmission based on the cached first control information.

According to embodiments of the disclosure, a communication method for an open radio access network (O-RAN) may be applied to an O-RAN radio unit (O-RU). The method may comprise caching first control information for a channel or signal transmitted periodically or repeatedly. The method may comprise performing subsequent transmission based on the cached first control information.

In an embodiment of the disclosure, the method may comprise receiving a control plane message transmitted by an O-RAN distributed unit (O-DU), the control plane message comprising at least one piece of the first control information.

In an embodiment of the disclosure, the first control information comprises first indication information for indicating whether to cache the first control information, the caching first control information comprises caching the first control information according to the first indication information for indicating whether to cache the first control information.

In an embodiment of the disclosure, the method may comprise determining whether to cache data to be transmitted that corresponds to the first control information, and if it is determined to cache the data to be transmitted, caching data to be transmitted in a user plane message transmitted by the O-DU. The performing subsequent transmission based on the cached first control information may comprise transmitting the cached data to be transmitted based on the cached first control information.

In an embodiment of the disclosure, the first indication information comprises a first information section extension. The first information section extension comprises at least one of a first extension field for indicating a section corresponding to the first control information, a second extension field for indicating activation or deactivation of caching the first control information, and a third extension field for indicating the remaining number of transmissions of the signal or channel.

In an embodiment of the disclosure, first information section extension further comprises a fourth extension field for indicating whether the O-RU caches data to be transmitted that corresponds to the section.

In an embodiment of the disclosure, if the second extension field is used for indicating the activation of caching the first control information, an indication value of the third extension field is 0, and the first information section extension further comprises a fifth extension field for indicating a transmission period of the signal or channel.

In an embodiment of the disclosure, if the second extension field is used for indicating the activation of caching the first control information, an indication value of the third extension field is not 0, and the first information section extension further comprises a sixth extension field for indicating a time-domain starting position of each repeated transmission of the signal or channel.

In an embodiment of the disclosure, the method may comprise clearing the cached first control information after the remaining number of transmissions indicated by the third extension field is transmitted based on the cached first control information.

In an embodiment of the disclosure, the method may comprise if the data to be transmitted in the user plane message transmitted by the O-DU has been cached, clearing the cached data to be transmitted after the remaining number of transmissions indicated by the third extension field is transmitted based on the cached first control information.

In an embodiment of the disclosure, if the second extension field is used for indicating the deactivation of caching the first control information, the method further comprises clearing the cached first control information according to the extension fields in the first information section extension.

In an embodiment of the disclosure, the method may comprise if the data to be transmitted that corresponds to the first control information has been cached, clearing the cached data to be transmitted.

In an embodiment of the disclosure, the extension fields in the first information section extension further comprise a seventh extension field for indicating the number of sections to be stopped.

In an embodiment of the disclosure, if an indication value of the seventh extension field is 0 for indicating that all sections in the O-RU stop to be transmitted, the first control information is all the cached control information. If the indication value of the seventh extension field is not 0, the first control information is control information corresponding to the section indicated by the first extension field in the cached control information, wherein the number of the first extension field is the same as the indication value of the seventh extension field.

In an embodiment of the disclosure, the first control information further comprises cached control plane information feedback indication information for indicating whether to feed back a recovery state of the cached control plane information. The method may comprise if it is determined to feed back the recovery state of each piece of the cached control plane information, indicating the recovery state of each piece of the cached control plane information as SUCCESSFUL through first information, and indicating the recovery state of each piece of the cached control plane information as FAILED through second information.

In an embodiment of the disclosure, the method may comprise updating a reception time window of a control plane message or a user plane message based on second control information.

According to embodiment of the disclosure, an open radio access network (O-RAN) radio unit (O-RU) may comprise a transceiver. The O-RU may comprise at least one processor coupled to the transceiver. The at least one processor is configured to cache first control information for a channel or signal transmitted periodically or repeatedly. The at least one processor is configured to perform subsequent transmission based on the cached first control information.

According to embodiments of the disclosure, a communication method for an open radio access network (O-RAN) may be applied to an O-RAN distributed unit (O-DU). The method may comprise transmitting first control information to an O-RAN radio unit (O-RU) for a channel or signal transmitted periodically or repeatedly, to instruct the O-RU to cache the first control information and perform subsequent transmission based on the cached first control information. The method may comprise receiving a first feedback message for caching the first control information transmitted by the O-RU.

According to embodiments of the disclosure, an open radio access network (O-RAN) distributed unit (O-DU) may comprise transceiver. The O-DU may comprise at least one processor coupled to the transceiver. The at least one processor is configured to transmit first control information to an O-RAN radio unit (O-RU) for a channel or signal transmitted periodically or repeatedly, to instruct the O-RU to cache the first control information and perform subsequent transmission based on the cached first control information. The at least one processor is configured to receive a first feedback message for caching the first control information transmitted by the O-RU.

The terms “first”, “second”, “third”, “fourth”, “1”, “2”, or the like (if present) in the specification and claims of the disclosure and the accompanying drawings above are used to distinguish similar objects and need not be used to describe a particular order or sequence. It should be understood that the data so used is interchangeable where appropriate so that embodiments of the disclosure described herein can be implemented in an order other than that illustrated or described in the text.

It should be understood that while the flow diagrams of embodiments of the disclosure indicate the individual operational steps by arrows, the order in which these steps are performed is not limited to the order indicated by the arrows. Unless explicitly stated herein, in some implementation scenarios of embodiments of the disclosure, the implementation steps in the respective flowcharts may be performed in other orders as desired. In addition, some, or all of the steps in each flowchart may include multiple sub-steps or multiple phases based on the actual implementation scenario. Some or all of these sub-steps or stages can be executed at the same moment, and each of these sub-steps or stages can also be executed at different moments separately. The order of execution of these sub-steps or stages can be flexibly configured according to requirements in different scenarios of execution time, and the embodiments of the disclosure are not limited thereto.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by an open radio access network (O-RAN) radio unit (O-RU), the method comprising:
caching first control information for a signal transmitted periodically or repeatedly; and
performing subsequent transmission based on the cached first control information.

2. The method of claim 1, further comprising:
receiving a control plane message transmitted by an O-RAN distributed unit (O-DU), the control plane message comprising at least one piece of the first control information.

3. The method of claim 2,
wherein the first control information comprises first indication information for indicating whether to cache the first control information, and
wherein the caching first control information comprises:
caching the first control information according to the first indication information for indicating whether to cache the first control information.

4. The method of claim 2, further comprising:
determining whether to cache data to be transmitted that corresponds to the first control information; and
if it is determined to cache the data to be transmitted, caching data to be transmitted in a user plane message transmitted by the O-DU,
wherein the performing subsequent transmission based on the cached first control information comprises:
transmitting the cached data to be transmitted based on the cached first control information.

5. The method of claim 3,
wherein the first indication information comprises a first information section extension, and
wherein the first information section extension comprises at least one of the following extension fields:
a first extension field for indicating a section corresponding to the first control information,
a second extension field for indicating activation or deactivation of caching the first control information, and
a third extension field for indicating the remaining number of transmissions of the signal.

6. The method of claim 5, wherein the first information section extension further comprises:
a fourth extension field for indicating whether the O-RU caches data to be transmitted that corresponds to the section.

7. The method of claim 5,
wherein, if the second extension field is used for indicating the activation of caching the first control information, an indication value of the third extension field is 0, and
wherein the first information section extension further comprises:
a fifth extension field for indicating a transmission period of the signal.

8. The method of claim 5,
wherein, if the second extension field is used for indicating the activation of caching the first control information, an indication value of the third extension field is not 0, and
wherein the first information section extension further comprises:
a sixth extension field for indicating a time-domain starting position of each repeated transmission of the signal.

9. The method of claim 8, further comprising:
clearing the cached first control information after the remaining number of transmissions indicated by the third extension field is transmitted based on the cached first control information.

10. The method of claim 9, further comprising:
if data to be transmitted in a user plane message transmitted by the O-DU has been cached, clearing cached data to be transmitted after the remaining number of transmissions indicated by the third extension field is transmitted based on the cached first control information.

11. The method of claim 5, wherein, if the second extension field is used for indicating the deactivation of caching the first control information, the method further comprises:
clearing the cached first control information according to the extension fields in the first information section extension.

12. The method of claim 11, further comprising:
if data to be transmitted that corresponds to the first control information has been cached, clearing cached data to be transmitted.

13. The method of claim 11, wherein the extension fields in the first information section extension further comprise:
a seventh extension field for indicating a number of sections to be stopped,
if an indication value of the seventh extension field is 0 for indicating that all sections in the O-RU stop to be transmitted, the first control information is all the cached control information; and
if the indication value of the seventh extension field is not 0, the first control information is control information corresponding to the section indicated by the first extension field in the cached control information, wherein a number of the first extension field is the same as the indication value of the seventh extension field.

14. The method of claim 3,
wherein the first control information further comprises cached control plane information feedback indication information for indicating whether to feed back a recovery state of the cached control plane information, and
wherein the method further comprises:
if it is determined to feed back the recovery state of each piece of the cached control plane information, indicating the recovery state of each piece of the cached control plane information as SUCCESSFUL through first information, and indicating the recovery state of each piece of the cached control plane information as FAILED through second information.

15. An open radio access network (O-RAN) radio unit (O-RU) comprising:
a transceiver;
memory, comprising one or more storage media, storing instructions; and
at least one processor communicatively coupled to the transceiver and the memory;
wherein the instructions, when executed by the at least one processor individually or collectively, cause the O-RU to:
cache first control information for a signal transmitted periodically or repeatedly, and
perform subsequent transmission based on the cached first control information.

16. The O-RU of claim 15, wherein the instructions, when executed by the at least one processor individually or collectively, further cause the O-RU to:
receive a control plane message transmitted by an O-RAN distributed unit (O-DU), the control plane message comprising at least one piece of the first control information.

17. The O-RU of claim 15,
wherein the first control information comprises first indication information for indicating whether to cache the first control information, and
wherein the instructions, when executed by the at least one processor individually or collectively to cache first control information, further cause the O-RU to:
cache the first control information according to the first indication information for indicating whether to cache the first control information.

18. The O-RU of claim 16, wherein the instructions, when executed by the at least one processor individually or collectively, further cause the O-RU to:
determine whether to cache data to be transmitted that corresponds to the first control information; and
if it is determined to cache the data to be transmitted, cache data to be transmitted in a user plane message transmitted by the O-DU,
wherein the instructions, when executed by the at least one processor individually or collectively to perform subsequent transmission based on the cached first control information, further cause the O-RU to:
transmit the cached data to be transmitted based on the cached first control information.

19. A method performed by an open radio access network (O-RAN) distributed unit (O-DU), the method comprising:
transmitting, to an O-RAN radio unit (O-RU), first control information for a signal transmitted periodically or repeatedly, wherein the first control information is used to instruct the O-RU to cache the first control information and perform subsequent transmission based on the cached first control information; and
receiving, from the O-RU, a first feedback message for the first control information.

20. The method of claim 19,
wherein the first control information comprises first indication information for indicating whether to cache the first control information.
